(19) United States
(12) Patent Application Publication
(10) Pub. No.: US 2008/0209436 A1
(43) Pub. Date: Aug. 28, 2008

(54) Automated testing of programs using race-detection and flipping

(76) Inventors: Gul Agha, Champaign, IL (US); Koushik Sen, Kensington, CA (US)

Correspondence Address: SADLER, BREEN, MORASCH & COLBY, P.S., 422 W. RIVERSIDE AVE., SUITE 424, SPOKANE, WA, 99201, US

(21) Appl. No.: 11/923,060

(22) Filed: Oct. 24, 2007

Related U.S. Application Data
(60) Provisional application No. 60/854,124, filed on Oct. 25, 2006.

(51) Int. Cl. G06F 9/46

(52) U.S. Cl. 718/106

(57) ABSTRACT

In accordance with one or more aspects, one or more programs having multiple actors is executed following a first execution path. A race condition among different ones of the multiple actors in the first execution path is identified, and an order in which two events involved in the race condition are executed is flipped so as to create a second execution path. The multiple actors are then executed following the second execution path, and any errors identified in the first execution path or the second execution path are reported.

### RELATED APPLICATIONS

This application claims the benefit under 35 U.S.C. §119(e) of U.S. Provisional Application No. 60/854,124 filed Oct. 25, 2006, which is hereby incorporated by reference herein.

### GOVERNMENT LICENSE RIGHTS

This invention was made with Government support under Grant Number N00014-02-1-0715 awarded by the Office of Naval Research (ONR), and Grant Number CNS 05-09321 awarded by the National Science Foundation (NSF). The Government has certain rights in the invention.

### BACKGROUND

Testing computer programs has historically been a difficult and time-consuming process due to the numerous possible inputs to typical programs and the numerous different execution paths that typical programs can take. Testing has become even more difficult as computer programs has become more complex. Additionally, many computer programs can be run in a multi-thread environment in which different portions (referred to as threads) of the programs are run concurrently. Such multi-threaded programs are even more difficult to test because they include the additional level of complexity of different orders in which instructions from the different threads can be executed.

### SUMMARY

Automated testing of programs using race-detection and flipping is discussed herein.

In accordance with one or more aspects, one or more programs having multiple actors is executed following a first execution path. During the execution, symbolic constraints and causal relations can be noted. A race condition among different ones of the multiple actors or in the messages to such actors in the first execution path is identified, and an order in which two events involved in the race condition are executed is flipped so as to create a second execution path which would result in different causal relations. The multiple actors are executed following the second execution path, and any errors identified in the first execution path or the second execution path are reported. In one or more embodiments, the input data and race conditions are systematically modified for successive executions so that all (or most) causally different paths are executed insofar as is feasible while re-executing paths which would produce redundant bugs is avoided.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 is an example of a computing device that can be used to implement the software testing technique described herein.

FIG. 2 is a flow diagram that illustrates one embodiment of a process for automated testing of programs using race-detection and flipping.

FIG. 3 illustrates an example program.

FIG. 4 is a block diagram illustrating example program modules and program data for implementing an instrumentation portion for the present software testing technique within the computing device shown in FIG. 1.

FIG. 5 is a block diagram illustrating example program modules and program data for implementing one embodiment of a runtime portion for the present software testing technique within the computing device shown in FIG. 1.

FIG. 6 illustrates an example syntax for a simple C-like language that is used when performing the instrumentation portion for the present software testing technique.

FIG. 7 illustrates an example procedure written with the C-like language shown in FIG. 6 before and after instrumentation in accordance with one embodiment of the present software testing technique.

FIG. 8 is a flow diagram that illustrates one embodiment of a software testing process that operates within the runtime portion of the present software testing technique.

FIG. 9 is a flow diagram that illustrates one embodiment of a process for providing a test input which is suitable for use within the software testing process of FIG. 8.

FIG. 10 is a flow diagram that illustrates one embodiment of a process for handling a pointer input graph which is suitable for use within the process for providing a test input of FIG. 9.

FIG. 11 is a flow diagram that illustrates one embodiment of a process for symbolically executing an assignment statement which is suitable for use within the software testing process of FIG. 8.

FIG. 12 is a flow diagram that illustrates one embodiment of a process for symbolically evaluating a conditional statement which is suitable for use within the software testing process of FIG. 8.

FIG. 13 is a flow diagram that illustrates one embodiment of a process for checking the predicted path which is suitable for use within the software testing process of FIG. 8.

FIG. 14 is a flow diagram that illustrates one embodiment of a process for solving constraints and determining a new logical input map which is suitable for use within the software testing process of FIG. 8.

FIG. 15 is a flow diagram that illustrates one embodiment of a process for determining a new logical input map when pointers are represented within the logical input map which is suitable for use within the process for solving constraints of FIG. 14.

FIG. 16 is a flow diagram that illustrates one embodiment of a process for updating the symbolic states suitable for use within the process 900 of FIG. 11 when the expression in the assignment statement is a variable.

FIG. 17 is a flow diagram that illustrates one embodiment of a process for updating the symbolic states suitable for use within the process 900 of FIG. 11 when the expression in the assignment statement is an addition or subtraction.

FIG. 18 is a flow diagram that illustrates one embodiment of a process for updating the symbolic states suitable for use within the process 900 of FIG. 11 when the expression in the assignment statement is a multiplication.

FIG. 19 is a flow diagram that illustrates one embodiment of a process for updating the symbolic states suitable for use within the process 900 of FIG. 11 when the expression in the assignment statement is a pointer de-reference.

### DETAILED DESCRIPTION

Automated testing of programs using race-detection and flipping is discussed herein. Generally, the automated testing is a software testing technique that identifies race conditions between various statements in the execution of a program. The program is executed with the multiple threads or processes or actors or agents being executed according to a particular schedule. The automated testing identifies race conditions, then backtracks and re-executes the program according to a different schedule in which the order of execution of the instructions in the race condition is flipped. This process continues for multiple possible distinct execution paths of the program. The automated testing can also be used in conjunction with concrete execution and symbolic execution testing of the program to avoid unnecessary flips, as discussed in more detail below.

For ease of explanation, the automated testing techniques are discussed herein with reference to multi-threaded programs. It is to be appreciated, however, that multi-threaded programs are merely one example of the use of these techniques, and that the techniques discussed herein can be applied to various actors in different situations. In one or more embodiments, the multiple threads of a program are the multiple actors to which the techniques discussed herein apply. In one or more other embodiments, the techniques discussed herein are applied to distributed memory message passing concurrent programs. In such embodiments, the actors are processes or agents, and the choice of messages to such processes or agents instead of access to shared variables is considered (e.g., considering sending a message to a same process or agent rather than accessing a same memory location or same shared variable).

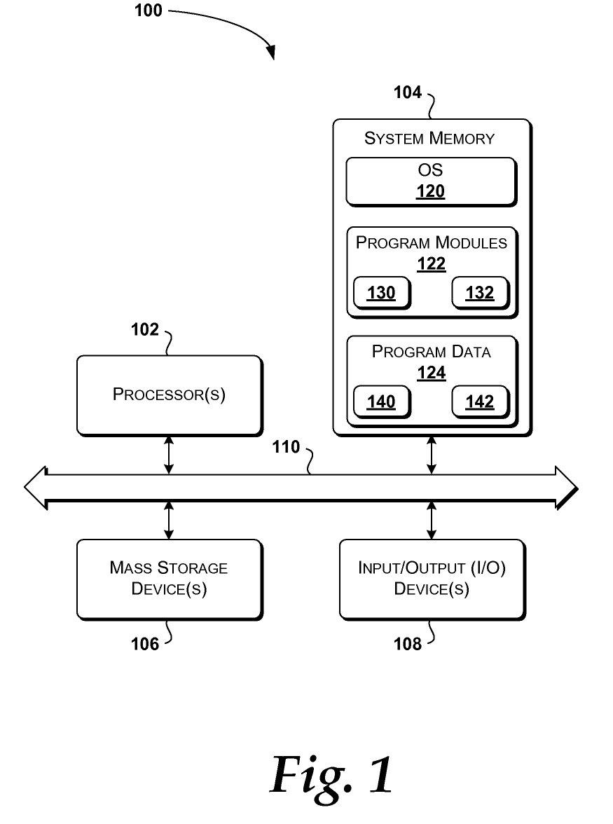

FIG. 1 is an illustrative computing device 100 that may be used to implement an embodiment of the present software testing technique described herein. Computing device 100 represents any type of computing device such as a desktop computer, a server computer, a handheld computer, a notebook computer, and the like.

Computing device 100 includes one or more processor(s) 102, system memory 104, mass storage device(s) 106, input/output (I/O) device(s) 108, and bus 110. Processor(s) 102 include one or more processors or controllers that execute instructions stored in system memory 104 and/or mass storage device(s) 106. Processor(s) 102 may also include computer readable media, such as cache memory.

System memory 104 includes various computer readable media, including volatile memory (such as random access memory (RAM)) and/or nonvolatile memory (such as read only memory (ROM)). System memory 104 may include rewritable ROM, such as Flash memory. System memory 104 typically includes an operating system 120, one or more program modules 122, and program data 124. For the present software testing technique, program modules 122 may include one or more components (e.g., components 130 and 132) for implementing an instrumentation portion and a runtime portion for the software testing technique, respectively. Likewise, program data 124 may include one or more data (e.g., data 140 and 142) for storing instrumented code and runtime data in accordance with the present software testing technique. The program modules 122 and program data 124 for implementing the instrumentation portion and runtime portion are described in detail in conjunction with the remaining figures.

Mass storage device(s) 106 include various computer readable media, such as magnetic disks, optical disks, solid state memory (e.g., flash memory), and so forth. Various drives may also be included in mass storage device(s) 106 to enable reading from and/or writing to the various computer readable media. Mass storage device(s) 106 include removable media and/or non-removable media.

I/O device(s) 108 include various devices that allow data and/or other information to be input to and/or output from computing device 100. Examples of I/O device(s) 108 include cursor control devices, keypads, microphones, monitors or other displays, speakers, printers, network interface cards, modems, lenses, CCDs or other image capture devices, and so forth.

Bus 110 allows processor(s) 102, system memory 104, mass storage device(s) 106, and I/O device(s) 108 to communicate with one another. Bus 110 can be one or more of multiple types of buses, such as a system bus, PCI bus, IEEE 1394 bus, USB bus, and so forth.

Various modules and techniques may be described herein in the general context of computer-executable instructions, such as program modules, executed by one or more computers or other devices. Generally, program modules include routines, programs, objects, components, data structures, etc. for performing particular tasks or implementing particular abstract data types. Typically, the functionality of the program modules may be combined or distributed as desired resulting in various embodiments.

Additionally, it should be noted that, although the techniques discussed herein are oftentimes discussed with reference to software, the techniques are also applicable to testing of firmware.

The present software testing technique, automated testing using race-detection and flipping, determines the race conditions (data race and/or lock race) between the various events in the execution path. An event in the execution path refers to the execution of a statement in the program by a thread. Two events are determined to be in a race (a race condition exists at the events) if the following three conditions are satisfied:
they are the events of different threads;
they access (e.g., read, write, lock, or unlock) the same memory location without holding a common lock; and
the order of the happening of the events can be permuted by changing the schedule of the threads.
   The events involved in those races are systematically re-ordered by generating new thread schedules as well as new test inputs.

New test inputs can be determined in different manners, such as randomly, in accordance with some fixed pattern or technique, in accordance with some other process or algorithm, and so forth. In one or more embodiments, new test inputs are determined so as to attempt to force new execution paths in the program to be executed. For example, if a test input value of “1” and “3” both resulted in the same execution path in the program, but a test input value of “2” resulted in a different execution path in the program, and if the initial test input value were “1”, then a new test input value of “2” would be a better selection than “3” as it will result in a different execution path in the program being followed and tested. New test inputs can be determined by selecting a constraint from symbolic constraints that were collected along the execution path and negating the selected constraint to define a new path constraint. Concrete value(s) are then found, if possible, that satisfy the new path constraint. If found, these value(s) are used as input for the next execution. If not found, then a different constraint is selected and/or a new thread schedule is selected. These symbolic constraints and concrete values are discussed in more detail below.

A new thread schedule is generated by picking two events that are in a race and generating a new schedule that, at the point where the first event happened, the execution of the thread involved in the first event is postponed or delayed. This flips or permutes the events involved in the race when the program is executed with the new schedule. In other words, the events are re-ordered so that the first event is executed in the new schedule after the second event involved in the race. In one or more embodiments, the execution of this thread is postponed or delayed as much as possible, although alternatively the execution of this thread may be postponed or delayed less. For example, any postponement or delay that results in the events being flipped can be used.

The identification of events involved in races and the re-ordering of events to generate new thread schedules, as well as the generation of new test inputs based on negating symbolic constraints as discussed above, allows the possible execution paths in the program being tested to be more efficiently tested. Rather than relying solely on random inputs in a hope that different execution paths are generated, constraints are negated and inputs found that will cause the different execution paths to be evaluated. Furthermore, race conditions in the different execution paths are evaluated and the threads are re-ordered to determine whether they result in error conditions.

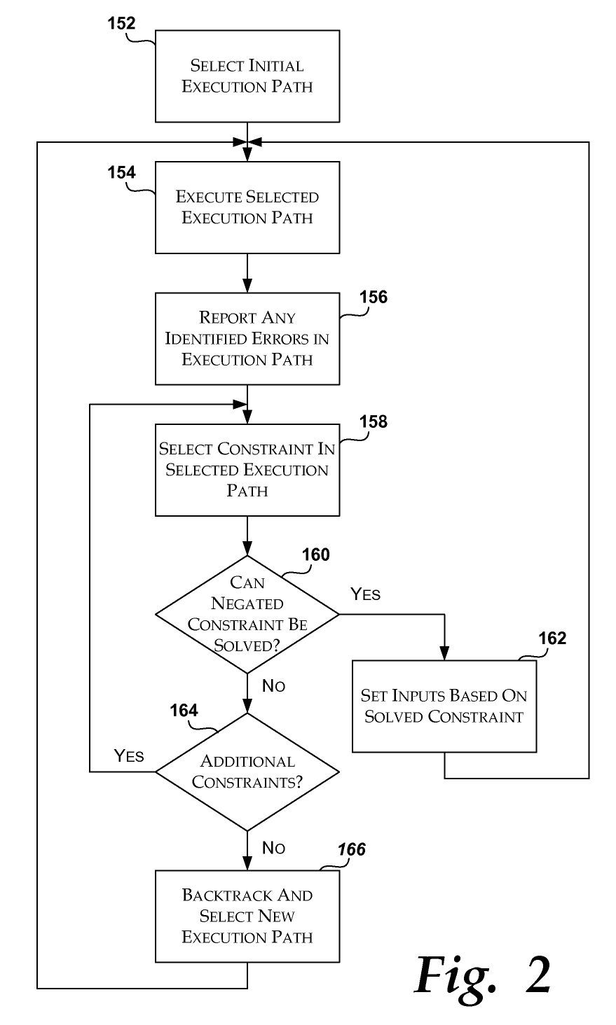

FIG. 2 is a flow diagram that illustrates one embodiment of a process for automated testing of programs using race-detection and flipping. The process of FIG. 2 begins at decision block 152 where an initial execution path is selected. The particular execution path that is selected is typically based on the initial test input values that are selected for the program. Different test input values can result in different execution paths. Although the instructions in this initial execution path may not be readily identifiable before the program is executed, selection of an initial set of test input values inherently selects an initial execution path. The initial set of test input values can be selected in any of a variety of manners, such as in accordance with some algorithm or process, randomly, and so forth.

The initial execution path also includes a particular order in which the multiple threads or processes or actors or agents of the program are to be executed. In one or more embodiments, the threads are assigned identifiers (e.g., thread 1, thread 2, thread 3, etc.), and the multiple threads are executed in their identifier order (e.g., thread 1 first, then thread 2, then thread 3, etc.). Alternatively, different orders may be initially selected, such as a random order, in the reverse of their identifier order, in accordance with some other criteria or algorithm, and so forth.

At block 154 the selected execution path is executed with the initial set of test input values. Various constraints and/or race conditions can be encountered during the execution of the selected execution path. A record of these constraints and/or race conditions is maintained during execution of the selected execution path and is used to subsequently select different execution paths as discussed in more detail below.

Any errors that are identified during execution of the selected execution path are reported in block 156. This reporting can take any of a variety of different forms, such as recording the error in a log, outputting the error to display or hard copy device, generating an alert (e.g., an alarm, an email message, etc.) for a tester of the program, and so forth. The errors can be identified in any of a variety of manners, such as execution of an instruction(s) indicating an error, attempted execution of an instruction that is incorrect (e.g., incorrect reference to a memory location or a type of data), and so forth.

After the selected execution path has been executed, a constraint in the selected execution path is selected at block 158. Typically multiple constraints will be collected during execution of the selected execution path, and in block 158 the most recently collected constraint that can be negated and result in an execution path that has not yet been executed as part of the testing process is selected in block 158. Alternatively, any of the collected constraints can be selected in block 158.

The selected constraint is then negated and a determination is made as to whether the negated constraint can be solved in block 160. For example, a particular constraint may be <2*z₀+1!=2> (where the symbol “!=” denotes “does not equal”), so the negated constraint would be <2*z₀+1=2>. Whether this can be solved depends on the techniques available for solving such equations, and the type requirements on the variables, particularly in this case the value of z₀.

If the negated constraint can be solved, then the test input values are set based on the solved constraint at block 162. By setting the test input values to negate the constraint, a different execution path will be encountered during the next execution of the program. The process then returns to block 154 where the newly selected execution path, based on the new test input values, is executed.

Returning to block 160, if the negated constraint cannot be solved, then a determination is made at block 164 whether there are any additional collected constraints that have not been negated. The process then returns to block 158 where one of those constraints is selected. In one or more embodiments, a record is also maintained of the different execution paths that have already been executed. In such embodiments, only those constraints that have not been negated and that, if negated, would result in an execution path that has not yet been executed are selected in block 158.

If there are no additional constraints, then at block 166 the process backtracks and selects a new execution path. This backtracking refers to re-ordering the threads for any race conditions that were identified in the executed execution path. If multiple race conditions were identified in the executed execution path, then one of those race conditions is selected. A particular one of multiple race conditions can be selected in different manners, such as randomly, or by using some bias such as priorities or other scheduling algorithm, the most recently encountered race condition is selected, the first race condition encountered is selected, and so forth. The process then returns to block 154 where the newly selected execution path, based on the new test input values and the re-ordered threads, is executed.

It should be noted that the order in which the different execution paths are analyzed can vary. In one or more embodiments, a depth-first approach is used. In the depth-first approach, a particular execution path is initially selected, and the data values and/or thread re-ordering occurs by selecting the most recently encountered constraints and/or race conditions. Alternatively, other approaches can be used, such as a breadth-first approach, a random selection, and so forth.

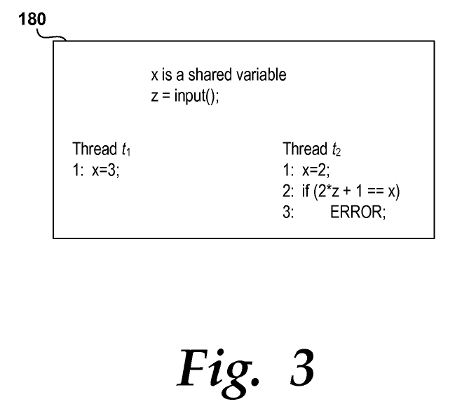

An example of the automated testing using race-detection and flipping can be seen with reference to FIG. 3, which illustrates a sample program P 180. Program P has two threads t₁ and t₂, a shared integer variable x, and an integer variable z which receives an input from the external environment at the beginning of the program. For ease of explanation, each statement in program P is labeled in FIG. 3. The program P reaches the ERROR statement in thread t₂ if the input to the program is 1 (i.e., z gets the value 1) and if the program executes the statements in the following order: (t₂,1) (t₁,1) (t₂,2) (t₃,3), where each event in the sequence is represented by a tuple of the form (t,l) denoting that thread t executes the statement labeled l.

The automated testing initially generates a random input for z and executes P with a default schedule. In one or more embodiments, the default schedule picks the thread which is enabled and which has the lowest index. Thus, the first execution of P following this default schedule is (t₁,1) (t₂,1) (t₂,2). Let z₀ be the symbolic value of z at the beginning of the execution. The constraints from the predicates of the branches executed in this path are collected, and for this first execution the path constraint <2*z₀+1!=2> is generated (where the symbol “!=” denotes “does not equal”). A race condition is determined to exist between the first and second events because both the events access the same variable x in different threads without holding a common lock and one of the accesses is a write of x.

Following the depth-first strategy, the only constraint 2*z₀+1!=2 is picked, negated, and an attempt is made to solve the negated constraint 2*z₀+1=2. No solution exists, so the process backtracks and generates a schedule such that the second execution becomes (t₂,1) (t₂,2) (t₁,1). In this example, the thread involved in the first event of the race in the previous execution is delayed as much as possible. The second execution thus re-orders the events involved in the race in the previous execution.

During the second execution, the path constraint <2*z₀+1!=2> is generated and a race condition is determined to exist between the second and third events. Since the negated constraint 2*z₀+1=2 cannot be solved, the process backtracks and generates a schedule such that the third execution becomes (t₂,1) (t₁,1) (t₂,2). The third execution thus re-orders the events involved in the race in the second execution.

During the third execution, the path constraint <2*z₀+1!=3> is generated and a race condition is determined to exist between the second and third events. The negated constraint 2*z₀+1=3 is solved to obtain z₀=1. In the fourth execution, the same schedule as the third execution is followed, however the process starts the execution with the input variable z set to 1 (which is the value of z that was computed by solving the constraint). The resultant execution becomes (t₂,1) (t₁,1) (t₂,2) (t₃,3), which hits the ERROR statement of the program P. The presence of this error, and optionally the execution path (t₂,1) (t₁,1)(t₂,2)(t₃,3) that lead to this error, can be reported to a tester of the program P.

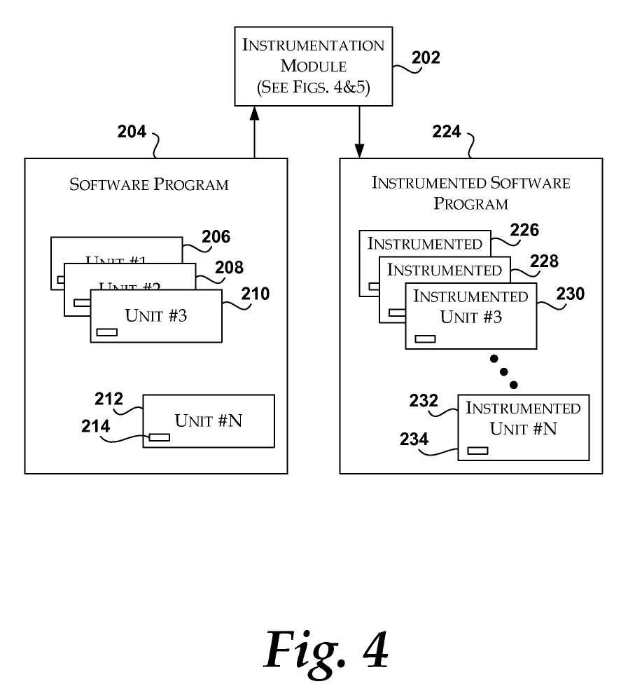

FIG. 4 is a block diagram illustrating an exemplary program module and exemplary program data for implementing an instrumentation portion for the present software testing technique within the computing device shown in FIG. 1. These techniques are further discussed in U.S. patent application Ser. No. 11/695,995, filed Apr. 3, 2007, entitled “Software Testing Technique Supporting Dynamic Data Structures”, which is hereby incorporated by reference herein. In overview, exemplary instrumentation module 202 adds instructions to a software program 204 which can then be tested in accordance with the runtime portion of the present software testing technique. Software program 204 may be written using a programming language, such as C programming language, JAVA programming language, or the like. Software program 204 may be decomposed into several units (i.e., units 206-212). Each of these units may have one or more functions. One of the functions in each unit is designated as an entry function (e.g., entry function 214). As will be described later, inputs are supplied to the entry function 214 in an iterative manner in order to explore the feasible paths of the corresponding unit. The entry function 214 may in turn call other functions within the unit as well as functions that are not in the unit (e.g., library functions). In one embodiment, the unit does not receive input from other sources, such as interactive input from a user, reading a file, a random number generator, or the like. Instead, the present software testing technique generates different inputs for each execution of the unit under test so that different execution paths are tested on each execution.

As mentioned above, each unit may have one or more functions. Each of these functions has statements, some of which are complex statements. Instrumentation module 202 converts the more complex statements into a simplified form by introducing temporary variables. For example, the statement “**v=3” may be converted into “t1=*v” and “*t1=3”; the statement “p[i]=q[j]” may be converted into “t2=q+j”, “t3=p+i”, and “*t3=*t2”. In one embodiment, instrumentation module 202 utilizes a conventional program, such as the CIL framework, to perform this conversion. Additional information about the CIL framework may be obtained from an article entitled “CIL: Intermediate Language and Tools for Analysis and Transformations of C Programs” by G. C. Necula et al. in Proceedings of Conference on Compiler Constructions, pages 213-228, 2002. Instrumentation module 202 may also handle function calls using a symbolic stack.

Instrumentation module 202 then adds instructions to the units 206-212 that are to be tested which results in a corresponding instrumented unit 226-232. While FIG. 4 illustrates each unit 206-212 having a corresponding instrumented unit 226-232, the present software testing technique tests each instrumented unit individually. Therefore, it is not necessary to instrument all the units. Rather, instrumentation module may instrument a portion of the units in software program 204 and then test all or some of these instrumented units.

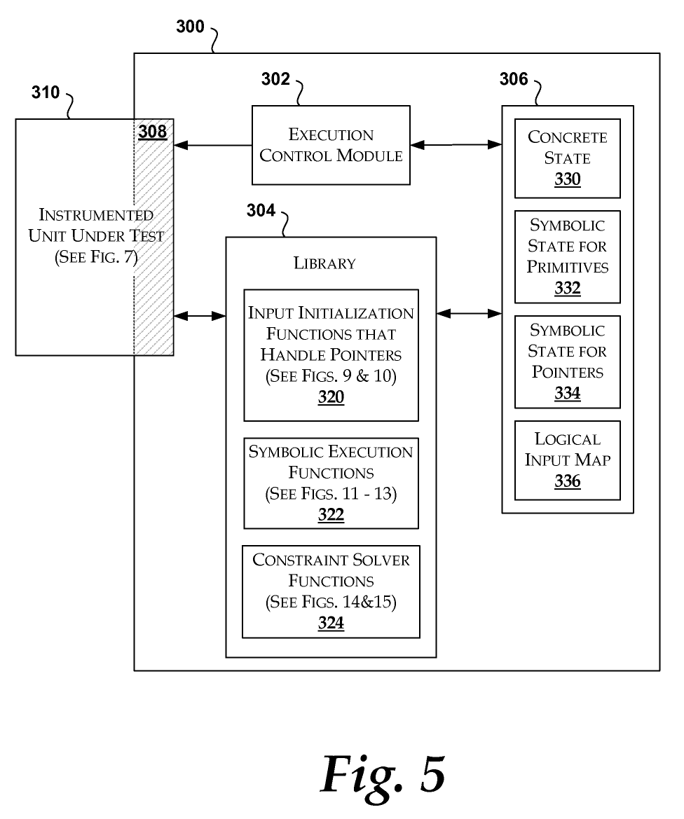

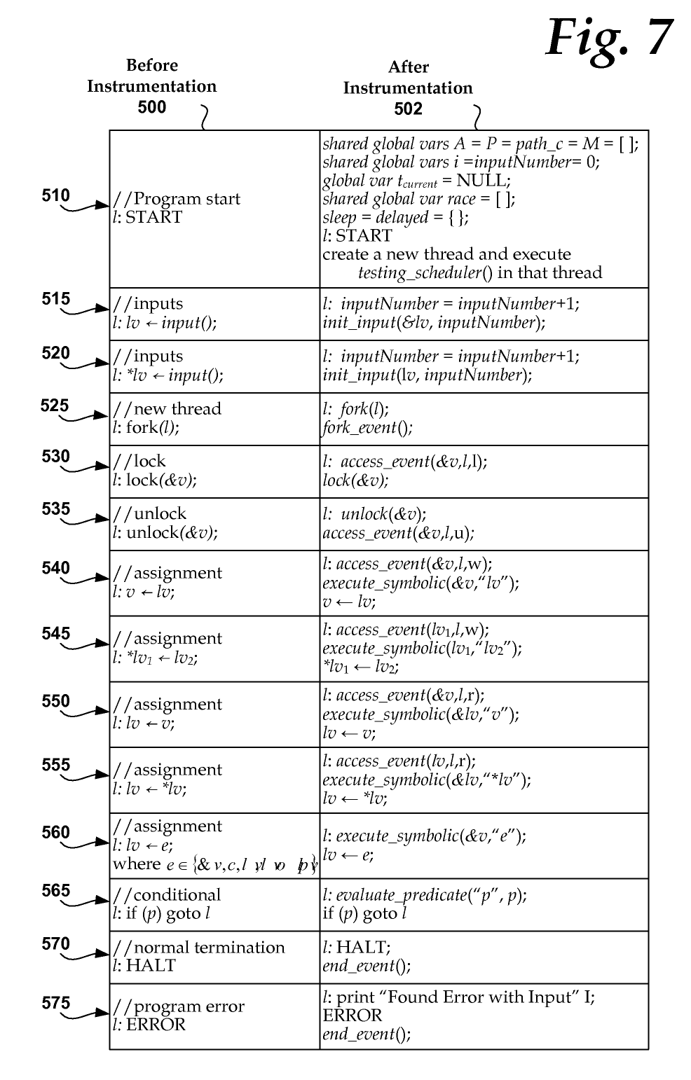

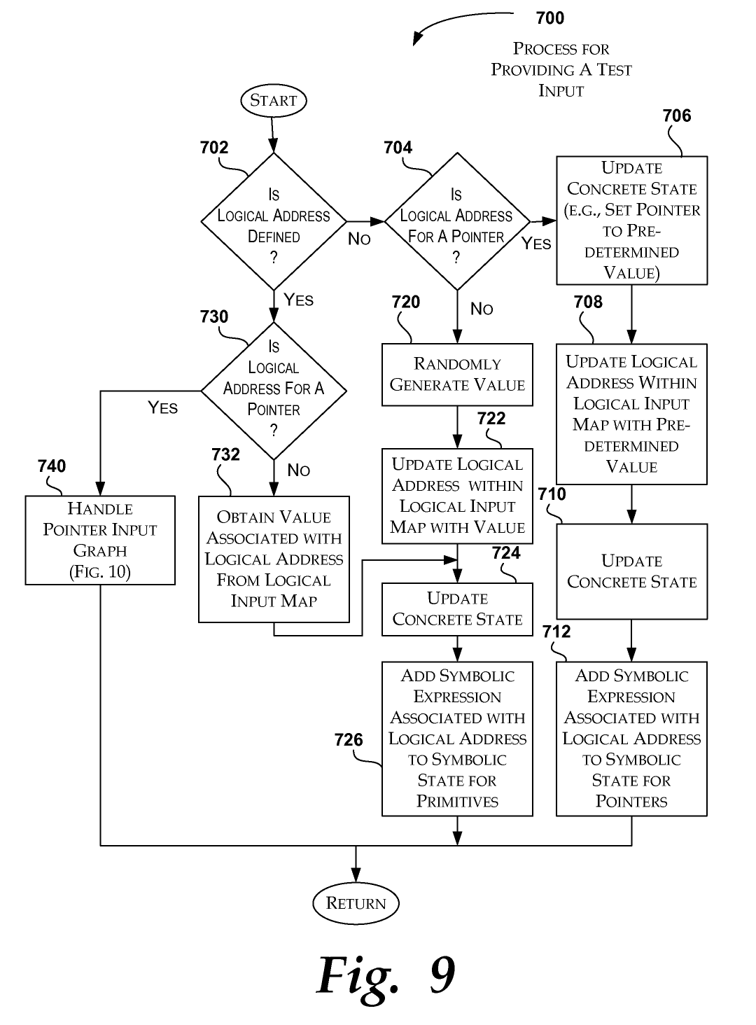

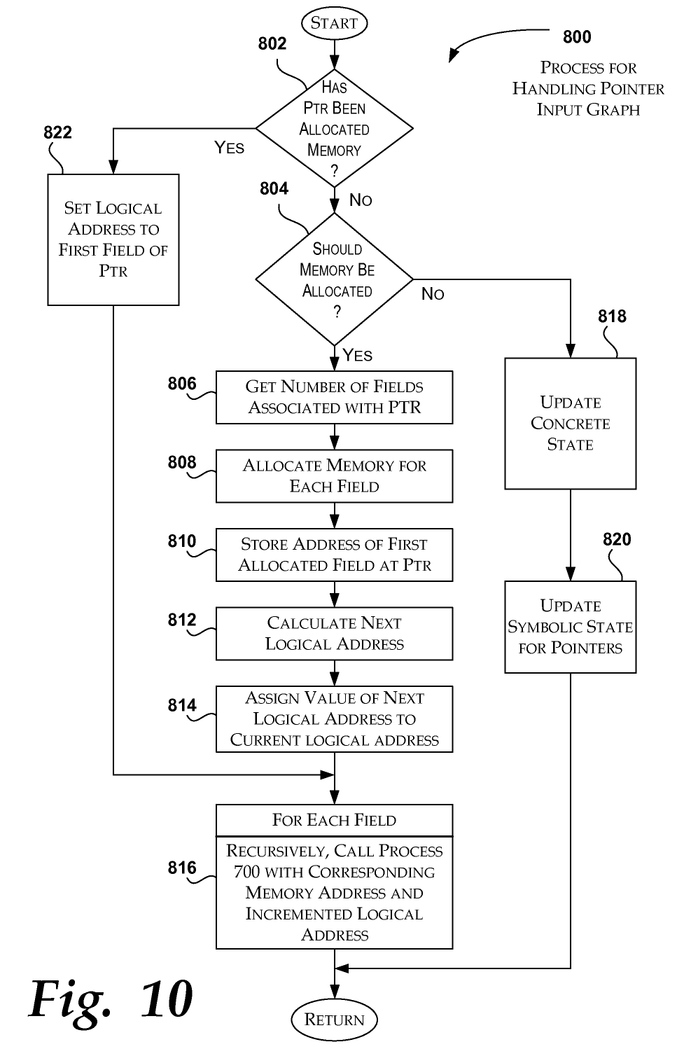

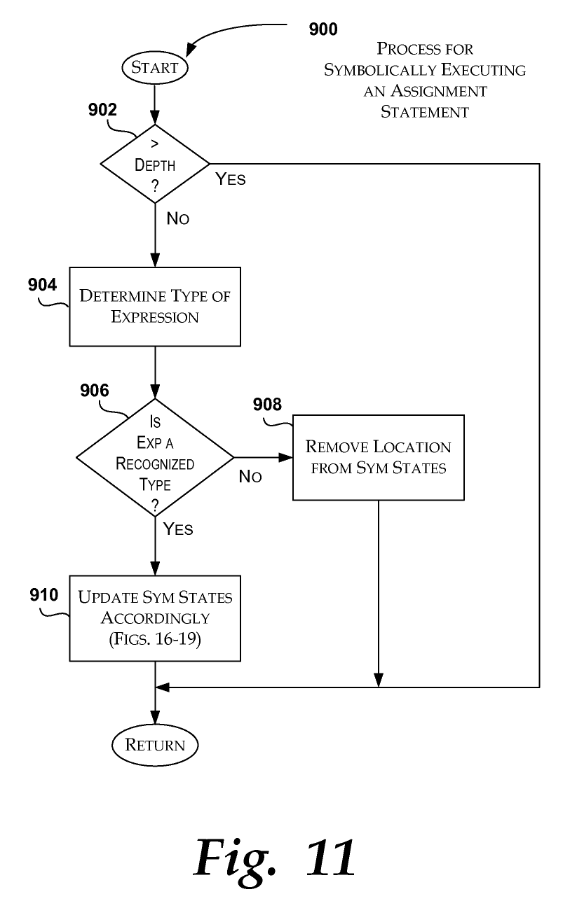

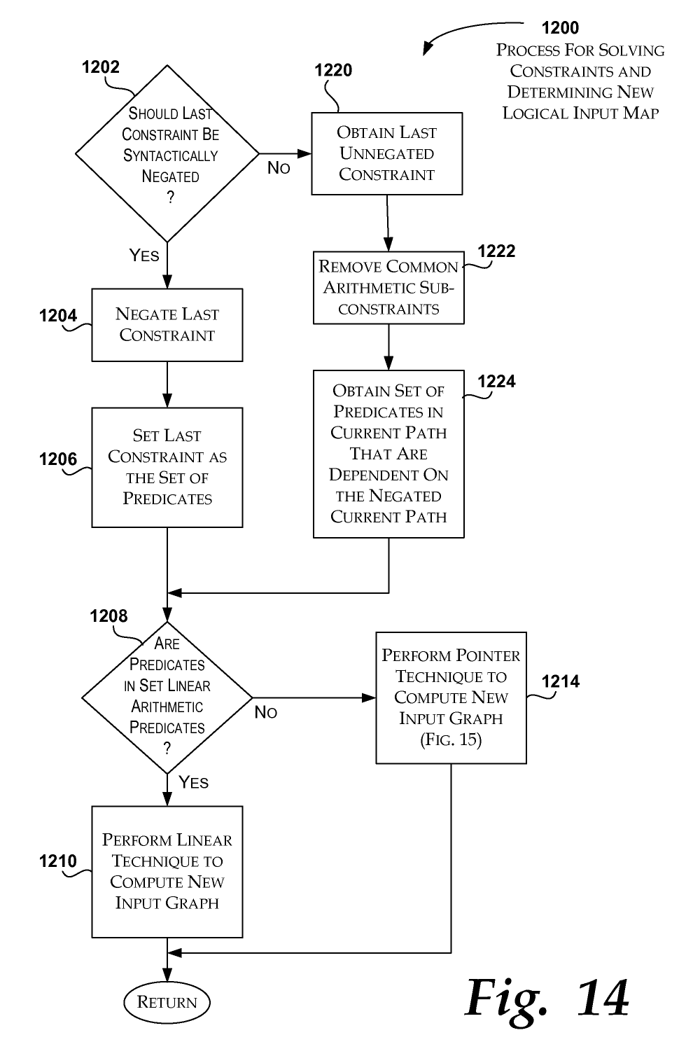

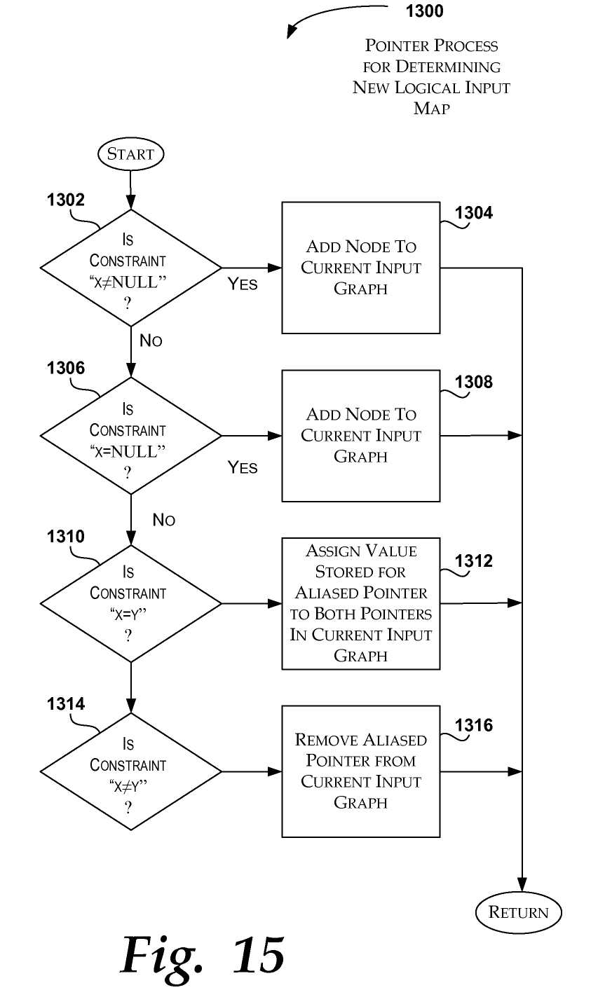

FIG. 5 is a block diagram illustrating exemplary program modules and program data for implementing one embodiment of a runtime portion 300 for the present software testing technique within the computing device shown in FIG. 1. The runtime portion 300 includes an execution control module 302, a library 304, runtime data 306, and instrumented code 308 (shown as a cross-hatched area within a unit under test 310; the area where the unit under test 310 and runtime portion 300 overlap). Briefly, the instrumented code 308, described later in detail in conjunction with FIG. 7, includes calls to functions within library 304. These calls include calls to input initialization functions 320, to symbolic execution functions 322, and to constraint solver functions 324. Input initialization functions 320, described in detail later in conjunction with FIGS. 9 and 10, initializes the memory locations for concrete execution and updates the runtime data 306, accordingly. Symbolic execution functions 322, described in detail later in conjunction with FIGS. 11-13, perform symbolic manipulations on statements and update the runtime data 306, accordingly. The constraint solver functions 324, described in detail later in conjunction with FIGS. 14 and 15, solve path constraints and update the runtime data 306, accordingly. The runtime data 306 includes a concrete state 330, a symbolic state for primitives 332, and a symbolic state for pointers 334, and a logical input map 336. Concrete state 330 maps a physical memory address to a concrete value (e.g., a primitive value or a pointer value). Symbolic states 332, 334 map a physical memory to an expression over symbolic values.

Execution control module 302 controls the execution of the instrumented unit under test 310 in a manner such that the feasible paths of the unit are executed until the testing completes. The testing may complete by traversing each feasible execution path, by obtaining a pre-specified branch or statement coverage, or the like. In overview, on each iteration of executing unit 310, the execution control module supplies inputs to the unit 310 via the instrumented code 308, and executes threads of the unit 310 in an order determined by the execution control module 302. The inputs that are supplied are based on the concrete execution and the symbolic execution of the previous execution as represented within the logical input map 336. As will be described below, the logical input map represents input for both primitive variables and pointer variables, which allows the present technique the ability to represent and track constraints that capture the behavior of a symbolic execution of an instrumented unit of code having pointers as inputs. The logical input map 336 is maintained between executions. However, the concrete state 330 and the symbolic states 332, 334 are not maintained between executions. As will be described below, the instrumented code 310 is simultaneously run concretely and symbolically, where simultaneous means that during one execution iteration, the instrumented code is executed both concretely and symbolically. In the embodiment described below, the symbolic execution of a statement precedes the concrete execution of the statement. However, the testing technique could be modified to allow the concrete execution of a statement to occur before the symbolic execution of the statement.

In overview, the logical input map 336 represents an input memory graph at the beginning of an execution. The input memory graph maps logical addresses to values that are either logical addresses or primitive values. Logical addresses are used instead of actual concrete addresses of dynamically allocated cells because the actual concrete addresses may change in different executions. It was discovered that the actual concrete addresses of the dynamically allocated cells were not necessary to represent in the memory graphs as long as the manner in which the dynamically allocated cells were connected were maintained. Thus, complex symbolic expressions involving pointers are represented as simple pointer variables within the logical input map. However, the precise pointer relations are maintained within the logical input map. For example, if p is an input pointer to a struct with a field f, then a constraint on p→f will be simplified to a constraint fₒ, where fₒ is the symbolic variable corresponding to the input value p→f. This allows simple pointer constraints of the form x=y or x≠y, where x and y are either symbolic pointer variables or the constant NULL. While this representation introduces some approximations, it was found that the constraints could be efficiently solved and did not appear to hinder the results. In addition, by separating the pointer constraints (i.e., symbolic state for pointers 334) from the arithmetic constraints (i.e., symbolic state for primitives 332), as will be described below, the constraint solving procedure is tractable and more efficient. One will note that constants need not be maintained within either of the symbolic states, but rather their values may be stored in the concrete state 330.

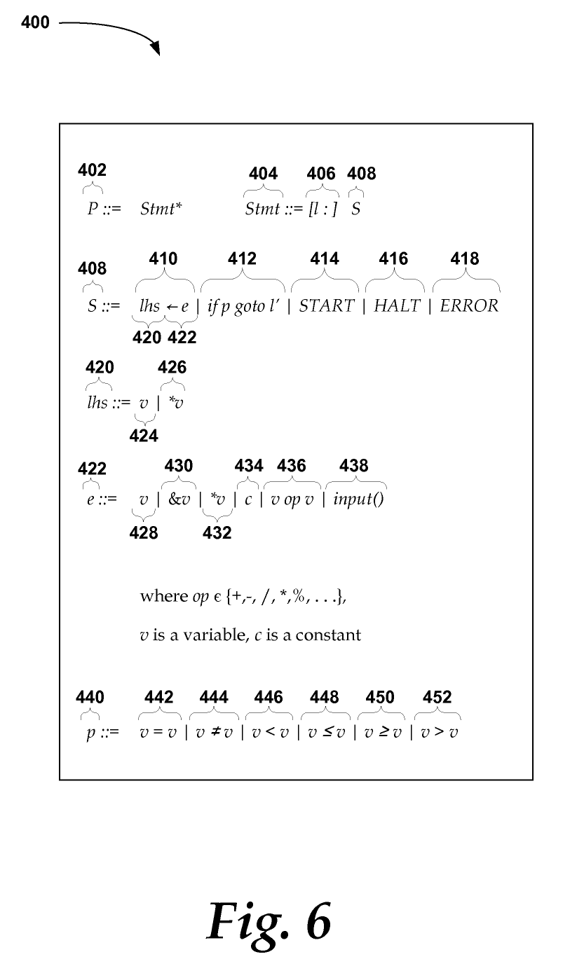

FIG. 6 illustrates an exemplary syntax 400 for a simple C-like language that is used when performing the instrumentation portion for the present software testing technique. While the above syntax for the C-like language is based on well known syntax constructs, it helps explain the processing performed by the instrumentation model 202 when instrumenting the unit under test so that the unit can be tested in accordance with the present software testing technique. In overview, syntax 400 defines a structure for statements within a software program.

In general a program 402 may have several lines of optionally labeled statements (i.e., a sequence of labeled statements). Each labeled statement 404 is in the form of an optional label (e.g., “l:”) 406 followed by a statement 408. Statement 408 may take the form of an assignment 410, a conditional 412, or a keyword (e.g., keywords 414-418). The left hand side 420 of the assignment 410 may be a variable 424 or a dereference 426. The right hand side is an expression 422 that may be a variable 428, an address 440 of a variable, a dereference 432, a constant 434, an operation 436 involving two variables, or input 438. The operation 436 may be any mathematical operation, such as +, −, /, *, and the like. The condition 440 (represented as “p”, which stands for “predicate”) in the conditional 412 may take one of several different forms, such as equal 442, not equal 444, less than 446, equal or less than 448, equal or greater than 450, greater than 452, and the like. The expression &v denotes the address of the variable v and the expression −v denotes the value at the address stored in v. Based on syntax 400, the instrumentation module 202 can instrument the unit under test 310 with instrumented code 308.

FIG. 7 illustrates some exemplary statements written with the C-like language shown in FIG. 6 before and after instrumentation in accordance with one embodiment of the present software testing technique. Code 500 illustrates exemplary statements in a unit under test before instrumentation and Code 502 illustrates the corresponding exemplary statements in an instrumented unit after instrumentation. Code 500 includes a START statement 510 (e.g., keyword 414) at the beginning of the program to designate the start of an entry function. The code also contains two input statements 515 and 520, which assign an input to a primitive variable and a pointer variable, respectively. As shown in FIG. 6, inputs (e.g., 438) are one example of an assignment statement (e.g., assignment 410). However, for the remaining discussion, input statements will be treated separately than other assignment statements so that their effect on the logical input map can be better understood. The code also contains five other assignment statements 540, 545, 550, 555, and 560. The code also contains a fork statement 525 to create a new thread, a lock statement 530 to lock access to a memory location, and an unlock statement 535 to unlock access to a memory location. The code further contains a conditional statement 565 (e.g., conditional 412 in FIG. 6) and two statements 570 and 575 with keywords (e.g., HALT keyword 416 and ERROR keyword 418). HALT keyword 570 denotes normal termination. ERROR keyword 575 denotes a program error in the code of the unit under test.

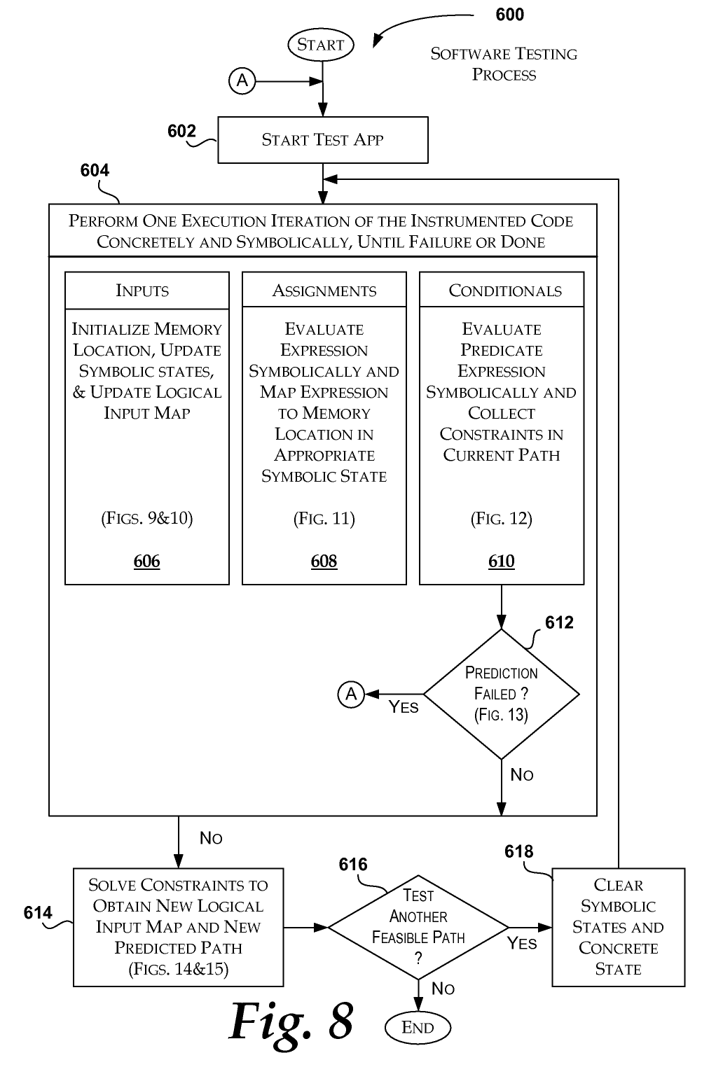

Instrumented code 502 illustrates the exemplary statements of instrumented code 500 after instrumentation is performed in accordance with the present software testing technique. Start statement 510 is instrumented to include four global assignment statements and a sleep statement in addition to a corresponding start statement. One global assignment statement assigns an empty set to global variables A, P, and M, which represent the symbolic state for primitives 332, the symbolic state for pointers 334, and the concrete state 330, respectively. This statement assigns an empty array to array path_c. Briefly, these global variables, described later in more detail when describing the software testing process in conjunction with FIG. 8, initialize the symbolic state for primitives, the symbolic state for pointers, the concrete state, and the execution path. A second global assignment statement assigns a value of zero to a counter i and an inputNumber variable. The inputNumber maintains a count for the number of inputs needed for executing code 502. As will be described later, the number of inputs needed is based on the number of original arguments to the functions under test, the number of pointers that are maintained in the symbolic state for pointers, and other inputs within the unit under test (if any).

A third global assignment initializes a variable t_{current} that stores the scheduled thread during execution. A fourth global assignment initializes a variable race used to keep track of whether a race condition has been detected. The sleep statement is used to delay the setting of the race variable when a race condition has been detected. The use of these variables during operation is discussed in more detail below. Additionally, a new thread is generated in which the testing_scheduler( ) code is executed.

Input statement 515 is instrumented with two statements, the first of which increments the inputNumber variable and the second of which calls a function (e.g., initInput( )) within library 304 that provides an input value to the variable v. Briefly, function initInput( ), described later in detail in conjunction with FIGS. 9 and 10, translates the logical input map into the concrete state and a corresponding symbolic variable for each input as designated by the corresponding logical address which is associated with the inputNumber. Input statement 520 similarly is instrumented with two statements, which increment the inputNumber variable and provide an input value to a pointer in this case.

Fork statement 525 is instrumented with two statements, a corresponding fork statement and a fork_event( ) statement, which is within library 304. The fork_event( ) statement allows execution of the newly forked thread to be paused, waiting for the testing_scheduler( ) to permit the newly forked thread to be executed.

Lock statement 530 is instrumented with two statements, a corresponding lock statement and an access_event( ) statement, which is within library 304. The access_event( ) statement is invoked before access to a potential shared memory location, and allows the testing_scheduler( ) to pause execution of the thread including lock statement 530. This allows the testing_scheduler( ) to control when the thread executes the lock statement.

Unlock statement 535 is instrumented with two statements, a corresponding unlock statement and an access_event( ) statement. The access_event( ) statement is invoked before access to a potential shared memory location, and allows the testing_scheduler( ) to pause execution of the thread including unlock statement 535. This allows the testing_scheduler( ) to control when the thread resumes execution after the unlock statement is executed.

Assignment statements 540, 545, 550, 555, and 560 are each instrumented to call a symbolic execution function (e.g., execute_symbolic( )) from within library 304 in addition to an assignment statement that corresponds to the original assignment statements 540, 545, 550, 555, and 560.

Conditional statement 565 is instrumented to call a symbolic execution function (e.g., evaluate_predicate( )), which is within library 304, in addition to the original conditional statement.

Keyword statement 570 is instrumented to first call the original keyword statement (i.e., HALT), and also invoke end_event( ). The end_event( ) is called after terminating a thread, and releases control to the testing_scheduler( ). Similarly, keyword statement 575 is instrumented to first print a message indicating that an error was found, then perform the original keyword statement (i.e., ERROR). The end_event( ) is also called.

Thus, as will be described, the runtime portion of the present software testing technique executes the instrumented code which simultaneously executes the code concretely using the original statements and symbolically via the instrumented calls to the input functions, the symbolic execution functions, and the constraint solver functions.

FIG. 8 is a flow diagram that illustrates one embodiment of a software testing process 600 that operates within the runtime portion of the present software testing technique. Process 600 begins at block 602, where the software testing application is started. In overview, the software testing application is started by specifying the instrumented unit that is to be tested. Given an entry function within the instrumented unit, a main function is generated that will initialize all the arguments of the function by calling an input( ) function. The entry function is then called with these arguments. The instrumented unit, along with the main function, forms a program that can be executed on its own.

In addition, a depth for a bounded depth first search (DFS) may be supplied or may default to a pre-determined value. In overview, the bounded depth first search allows the software testing process to explore paths in an execution tree using a depth first strategy. Each iteration of executing the instrumented code (except the first) executes with the help of a record of the branches that were traversed during prior executions. However, when the length of the execution paths are infinite or long enough to prevent exhaustive search of the whole computation tree, the specified value for the depth stops the present software testing technique from executing the instrumented code at a further depth, thus, preventing inefficient testing. The Table 1 contains pseudo-code that illustrates one embodiment for starting the test application with a bounded depth first search implemented.

```
TABLE 1
run_test(P, depth)
    I = [ ]; h = (number of argument in P) +1;
    completed = false; branch_hist = [ ]; event = [ ]; postponed = [ ];
    while not completed
        execute P
```

P represents the instrumented program to test, depth is the depth of the bounded DFS, I represents the logical input map, and branch_hist stores the branches that were traversed during the execution path of each iteration (e.g., path constraint). Thus, the branch_hist represents the execution paths that have already been tested. The logical input map I is initialized as an empty array at the beginning of the test and is, thereafter, updated and maintained after each execution iteration. As will be described below, during each execution iteration, the branch_hist array is updated to reflect the current path constraint. The instrumented unit of code (e.g., P) is then executed until the test is completed, which may occur upon an error, upon testing each of the execution paths, upon reaching the depth specified for the DFS, or the like. Processing continues at block 604. The event array is used to keep track of the sequence of events generated by an execution of P. Thus, the event array serves the same purpose as the global variable τ in the example discussed below with respect to Table 5. The postponed array identifies threads that are postponed and thus cannot be executed in the next execution of P.

At block 604, one execution iteration is performed on the instrumented code. As described above in conjunction with FIG. 7, the instrumented code executes input statements (block 606), assignment statements (block 608), and conditionals (block 610). Each of the statements within the instrumented code is executed symbolically and concretely as they are encountered. The concrete execution of the instrumented code uses conventional techniques and is not further described. The following describes the symbolic execution of the instrumented code.

At block 606, a test input is determined for each input statement that is encountered. The input statement may be encountered anywhere from the beginning to the end of the code. The logical input map is translated to obtain the concrete state and to update the symbolic state for the associated input. Briefly, determining the value for the test input, described in detail later in conjunction with FIGS. 9 and 10, initializes the memory location associated with the input and updates the symbolic states in accordance with the input. The goal is to have the values for the inputs cause a different execution path to be traversed during this execution iteration than prior execution paths.

At block 608, each assignment statement that is encountered is executed symbolically and concretely. As mentioned above, the instrumented code includes the original statements from the original software program along with the added instrumented calls to the symbolic execution functions. Briefly, the symbolic execution function for handling assignments (e.g., “execute_symbolic( )”), described in detail later in conjunction with FIG. 11, evaluates an expression symbolically and maps the expression to a memory location in the appropriate symbolic state.

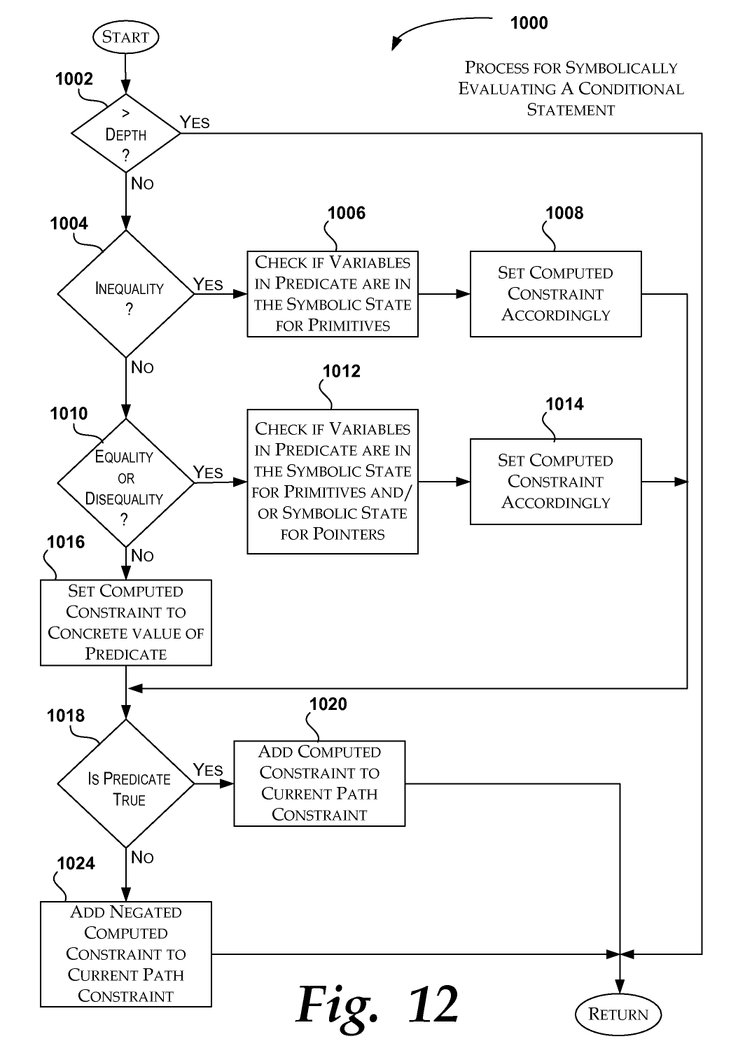

At block 610, each conditional statement that is encountered is executed symbolically and concretely. Briefly, the symbolic execution function for handling conditionals (e.g., “evaluate_predicate( )”), described in detail later in conjunction with FIG. 12, symbolically evaluates the predicate expression of the conditional statement, collects the constraint associated with the conditional statement, and represents the constraint in the current path constraint. The current path constraint is saved in the branch_hist array (described above).

After a conditional statement is processed, processing continues at decision block 612. At block 612, the current path is compared with the predicted path to determine whether testing is proceeding as expected. Upon noticing that the paths differ, processing may terminate and process 600 may be restarted. By restarting process 600, new inputs will be generated that will explore new paths. One will note that once testing is restarted, there is no predicted path for the first iteration. If the prediction is successful, another statement is processed by block 606, 608, or 610. Similarly, when blocks 606 and 608 complete processing of the current statement, the next statement is processed according to one of the blocks 606-610 until there is a failure or until all the statements have been processed.

At block 614, the constraints involving the symbolic variables are solved in order to obtain a new logical input map and a new predicted path, which are then saved. Briefly, solving the constraints, described in detail in conjunction with FIGS. 14-15, negates one of the constraints within the current path constraint, determines values which would satisfy the new path constraint, and saves the values in a new logical input map. The new logical input map is then used in initializing the concrete state and the symbolic states on the next iteration. Processing continues at decision block 616.

At decision block 616, a determination is made whether to test another feasible path. If each feasible path has been tested, processing is complete. An indication that no errors were found in the instrumented code may be provided or a report of all the errors discovered during testing may be reported. If another feasible path is to be tested, processing continues at block 618.

At block 618, the symbolic states and the concrete state are cleared. Thus, the subsequent iterations utilize the logical input map to initialize the contents of the concrete state and the symbolic states. Processing then loops back to block 604 where the new logical input map is used to initialize the concrete state and the symbolic states. The input, assignment, and conditional statements are executed as described above.

FIG. 9 is a flow diagram that illustrates one embodiment of a process for providing a test input which is suitable for use within the software testing process of FIG. 8. In overview, process 700 uses the logical input map to translate values into the concrete state and to create symbolic variables. Process 700 begins at decision block 702 where a determination is made whether the logical address is defined within the logical input map. In one embodiment, a counter, such as inputNumber, is used to identify logical addresses for the inputs. If the logical address has not been previously defined, such as for the first execution iteration for the arguments to the functions within the unit under test and subsequent execution iterations involving memory graphs of pointers, processing continues at block 704. Otherwise, processing continues at block 730.

At decision block 704, a determination is made whether the logical address is associated with a pointer. If the logical address is associated with a pointer, processing continues at block 706. Otherwise, processing continues at block 720.

At block 706, the concrete state is updated, accordingly. Thus, the physical address associated with the logical address is set to a pre-determined values, such as NULL (e.g., 0). Thus, the concrete state of the program will have a value of NULL for the pointer. Processing continues at block 708.

At block 708, the logical input map is updated with the pre-determined value for the associated logical address. In one embodiment, a representation of the logical input map may take the form of <l₁,l₂,l₃, . . . > where lₓ represents the value for logical address x. For example, if the pointer was the first and only input, the logical input map would appear as <0>. This representation of the logical input map provides a simple way to serialize a memory graph. The representation v=I(l) then refers to the value within the logical input map for logical address l. Processing continues at block 710.

At block 710, the pre-determined value is assigned to the physical address associated with the logical address. Thereby, updating the concrete state. Thus, the concrete execution will utilize this value during this execution. Processing continues at block 712.

At block 712, a symbolic variable associated with the logical address is added to the symbolic state for pointers. The symbolic variable at this time is equal to itself. As will be described, the symbolic variable may be modified later by an assignment statement. Adding the symbolic variable may utilize any conventional technique. However, for the present software testing technique, primitives and pointers are separated into their own symbolic states. Processing for this input is then complete. Process 700 is repeated each time an input statement is encountered within the instrumented code. After an input value has been provided for this input, processing returns to FIG. 8.

At decision block 704, if it is determined that the logical address is not a pointer, processing continues at block 720. In other words, the logical address is for a primitive variable. At block 720, a random value is generated. Any conventional technique for generating a random value may be utilized. Processing continues at block 722.

At block 722, the randomly generated value is stored in the logical input map associated with the current logical address. Processing continues at block 724.

At block 724, the randomly generated value is assigned to the physical address associated with the logical address. Thereby, updating the concrete state. Thus, the concrete execution will utilize this value during this execution. Processing continues at block 726.

At block 726, a symbolic variable associated with the logical address is added to the symbolic state for primitives. Again, the symbolic variable at this time is equal to itself. Processing for this logical address is then complete and returns to FIG. 8.

Referring back to decision block 702, the manner in which the decision whether the logical address has already been defined is now described in further detail. The determination is based on the logical input map. For example, on each execution iteration of the instrumented code, the inputNumber variable is reset to 0. Therefore, each argument to the entry function (see FIG. 7) utilizes the same inputNumber for each execution iteration. The inputNumber corresponds to the logical address within the logical input map. Therefore, after the first execution iteration, the logical input map will have values assigned for these logical addresses, which result in processing continuing at decision block 730.

At decision block 730, a determination is made whether the logical address is for a pointer. If the logical address is for a pointer, processing continues at block 740, otherwise, processing continues at block 732.

At block 732, a value associated with the logical address is obtained from the logical input map. Processing then proceeds to blocks 724 and 726, described above, where the concrete state and the symbolic state for primitives are updated accordingly. Processing for this logical address is then complete and returns to FIG. 8.

At decision block 730, if it is determined that the logical address is for a pointer, processing continues at block 740. Briefly, block 740, described in detail later in conjunction with FIG. 10, handles an input graph for the pointer. In other words, primitive variables and pointer variables referenced by the pointer are added to the appropriate symbolic state and to the concrete state, as needed. In addition, additional memory may be allocated to accommodate having the pointer fulfill a non-NULL constraint. Once the pointer input graph of block 740 is complete, processing returns to FIG. 8.

FIG. 10 is a flow diagram that illustrates one embodiment of a process for handling a pointer input graph which is suitable for use within the process for providing a test input illustrated in FIG. 9. In overview, process 800 attempts to provide “valid” input values for pointers so that the concrete execution can successfully execute when the constraint associated with the pointer specifies a non-NULL value. Processing begins at decision block 802.

At decision block 802, a determination is made whether the pointer has already been allocated memory. This determination is based on the value stored within the logical input map associated with the pointer. For example, in one embodiment, three values may be used in this determination: 1) a value of “0” represents that the pointer is NULL and there is no constraint forcing it to be non-NULL; 2) a value of “−1” represents that the pointer has not been allocated memory, but there is a constraint forcing it to be non-NULL; and 3) a positive integer represents that the pointer has been allocated memory and the value of the positive integer represents the logical address within the logical input map associated with the pointer's first field. Because pointers are initialized to NULL, the first time that a pointer proceeds through process 800, the process continues at decision block 804.

At block 804, a determination is made whether memory should be allocated. As outlined above, this occurs when the constraint solver has set a constraint such that the pointer should not be NULL. Processing then continues at block 806. However, if there is no constraint forcing the pointer to be non-NULL, processing continues at block 818.

At block 818, the concrete state associated with the current logical address (i.e., the pointer) is set to NULL using conventional techniques. Processing continues at block 820.

At block 820, the symbolic state for pointers is updated. The symbolic state for pointers is updated by adding a symbolic variable for the pointer into the symbolic state. As mentioned above in conjunction with FIG. 8, because the concrete state and the symbolic states are cleared before each iteration. Blocks 818 and 820 re-populate the data according to the new logical input map.

If memory needs to be allocated for the pointer at decision block 804, processing continues at block 806. At block 806, the number of fields associated with the pointer is obtained so that sufficient memory is allocated based on the type of pointer in block 808. At block 810, the concrete state for the pointer is updated by storing the address of the first allocated field in the pointer. At block 812, the next available logical address within the logical input map is calculated. Because the logical input map needs to expand in order to accommodate the fields for this pointer, the last logical address is incremented by one to obtain the next logical address. At block 814, the value of the next logical address is stored as the current logical address so that process 700 can be called recursively for each field at block 816. The logical address is incremented for each new field. Then, before returning to FIG. 8, the logical address is set to the next logical address after the pointer. Thereby, keeping the logical address associated with specific input consistent between iterations.

If memory has already been allocated, blocks 806-814 may be skipped and instead at block 822 the logical address is set to the logical address that corresponds to the first field of the pointer. This logical address is stored in the logical input map at the logical address associated with the pointer. By linking the pointer and its field in this manner within the logical input map, the logical input map provides a simple way to serialize a memory graph that includes pointer variables. Process 800 is then complete and returns to FIG. 8.

Table 2 illustrates exemplary code that provides input for primitive variables and pointer variables in accordance with the present software testing technique.

TABLE 2

```
// input: m is the physical address to initialize
// l is the corresponding logical address
// modifies h, I, A, P, M
initInput(m, l)
  if l ∉ domain(I)
    if (typeOf (*m) == pointer to T) *m = NULL;
    else *m = random( );
    I = I[l [symbol]  *m];
  else
    v = I(l);
    if (typeOf(v) == pointer to T)
      if (v ε domain(M))
        *m = M(v);
      else
        n = sizeOf(T);
        {m₁, . . . ,mₙ} = malloc(n);
        if (v == non-NULL)
            v' = h; h = h + n; // h is the next logical address
        else
            v' = I(l)
        *m = m₁; I = I[l [symbol]  v']; M = M[v [symbol]  m₁];
        for j = 1 to n
            input(mⱼ , h + j − 1);
    else
      *m = v; I = I[l [symbol]  v];
  // x₁ is a symbolic variable for logical address l
  if (typeOf(m)== pointer to T) P = P[m [symbol]  x₁];
  else A = A[m [symbol]  x₁];
```

FIG. 11 is a flow diagram that illustrates one embodiment of a process 900 for symbolically executing an assignment statement which is suitable for use within the software testing process of FIG. 8. Process 900 begins at an optional decision block 902. Optional decision block 902 is implemented if a depth has been set for a bounded depth first search. At decision block 902, a determination is made whether the set depth has been reached. Having a bounded depth-first search allows the present software testing technique the ability to generate a variety of finite sized data structures when using preconditions such as data structure invariants. For example, if an invariant is used to generate sorted binary trees, a non-bounded depth-first search would result in an infinite number of trees whose every node has at most one left children and no right children. Thus, in one embodiment, the depth is assigned a default value which may be overridden with a user supplied value. If the depth has been reached, symbolic processing is not performed and processing proceeds to the return. Otherwise, processing continues at block 904.

At block 904, the type of expression in the assignment statement is determined. As discussed in conjunction with FIG. 6, an expression may be a variable 428, an address 440 of a variable, a dereference 432, a constant 434, an operation 436 involving two variables, or input 438. Processing continues at decision block 906.

At decision block 906, a determination is made whether the type of expression is a recognized type. If the type of expression is not a recognized type of expression, processing continues at block 908 where the location(s) are removed from the symbolic states. However, if the type of expression is a recognized type of expression, processing continues at block 910.

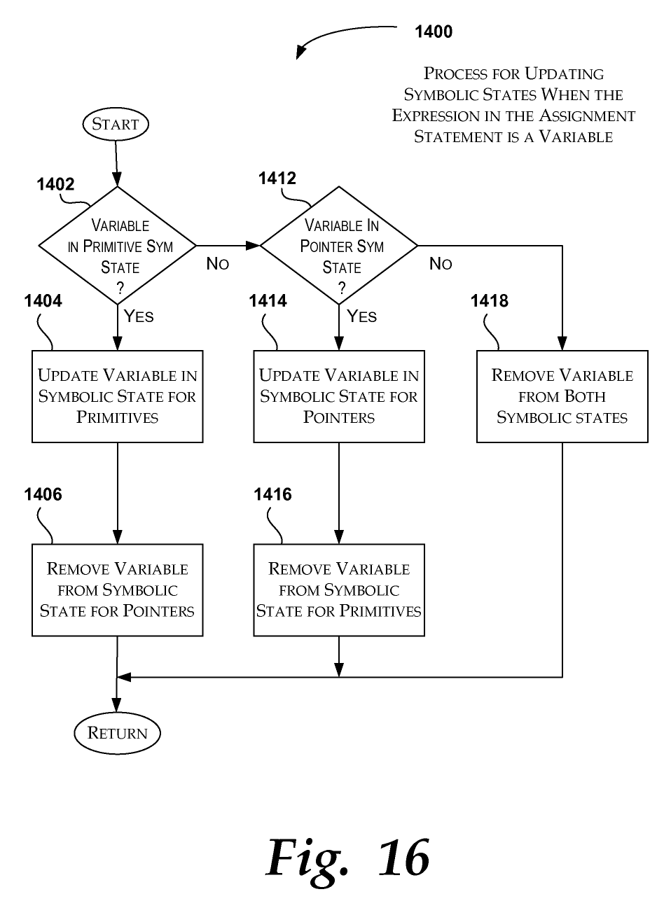

At block 910, the symbolic states are updated according to the type of expression. FIGS. 16-19 illustrate how the symbolic states are updated for different types of expression. Processing 900 is then complete.

FIG. 16 is a flow diagram that illustrates one embodiment of a process for updating the symbolic states suitable for use within the process 900 of FIG. 11 when the expression in the assignment statement is a variable assignment, such as y x, where the assignment may be for pointers or for primitives. At decision block 1402, a determination is made whether x is in the symbolic state for primitives. If it is, processing continues at block 1404 and block 1406. At block 1404, the symbolic state for primitives is updated to reflect that the symbolic state of y is now equal to the symbolic state of x. At block 1406, x is removed from the symbolic state for pointers, if it exists in the symbolic state for pointers. Processing then returns.

If x is not in the symbolic state for primitives, processing continues at decision block 1412, where a determination is made whether x is in the symbolic state for pointers. If it is, processing continues at block 1414 and block 1416. At block 1414, the symbolic state for pointers is updated to reflect that the symbolic state of y is now equal to the symbolic state of x. At block 1416, x is removed from the symbolic state for primitives if it exists there. Processing then returns.

If x is not in either the symbolic state for primitives or the symbolic state for pointers, processing continues at block 1516 where x is removed from both symbolic states. Processing then returns.

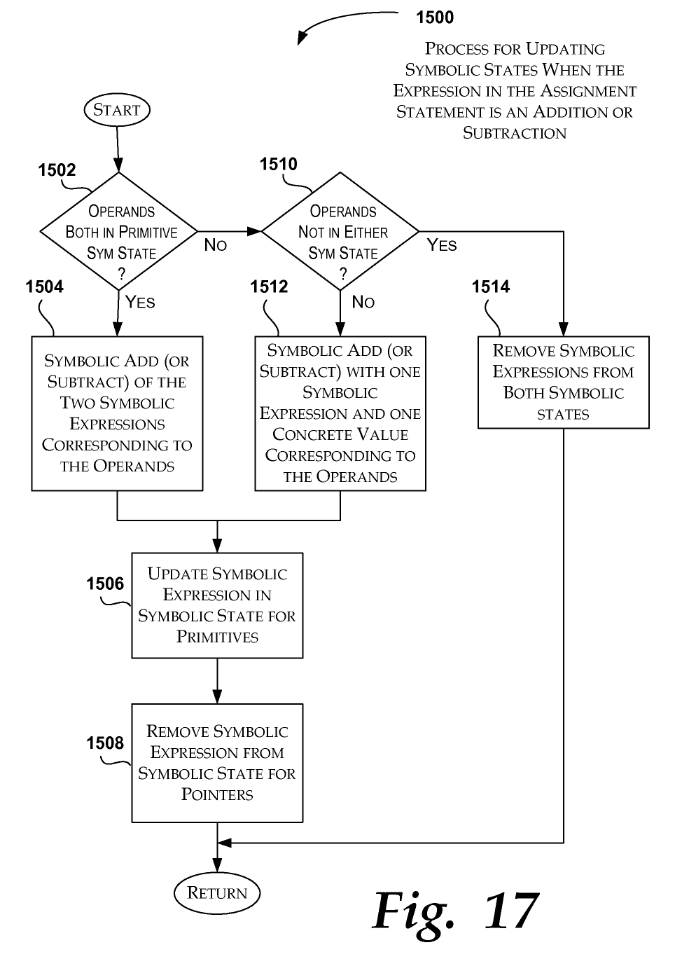

FIG. 17 is a flow diagram that illustrates one embodiment of a process for updating the symbolic states suitable for use within the process 900 of FIG. 11 when the expression in the assignment statement is an addition or subtraction. At decision block 1502, a determination is made whether both operands are in the symbolic state for primitives. Because the present testing technique has pointer constraints that are either “equal to NULL”, “not equal to NULL”, “equal to”, or “not equal to”, process 1500 does not need to check the symbolic state for pointers. Even though this is not precise, the technique scales better, runs faster, and achieves successful results. If both operands are in the symbolic state for primitives, processing continues at block 1604 where a symbolic add (or subtract) with two symbolic expressions is performed. Processing continues at where the left hand operand is updated in the symbolic state for primitives (block 1506) and is removed from the symbolic state for pointers (block 1508). Processing then returns.

If both operands are not in the symbolic state for primitives, processing continues at decision block 1510. At decision block 1510, a determination is made whether one of the operands is in the symbolic state for primitives. If this is true, a symbolic add (or subtract) is performed the one operand in the symbolic state for primitives and a concrete value corresponding to the other operands (block 1512). Processing then continues to block 1506 and 1508 before returning.

If there is not an operand within the symbolic state for primitives, the symbolic expression is removed from both symbolic states. Processing is then complete.

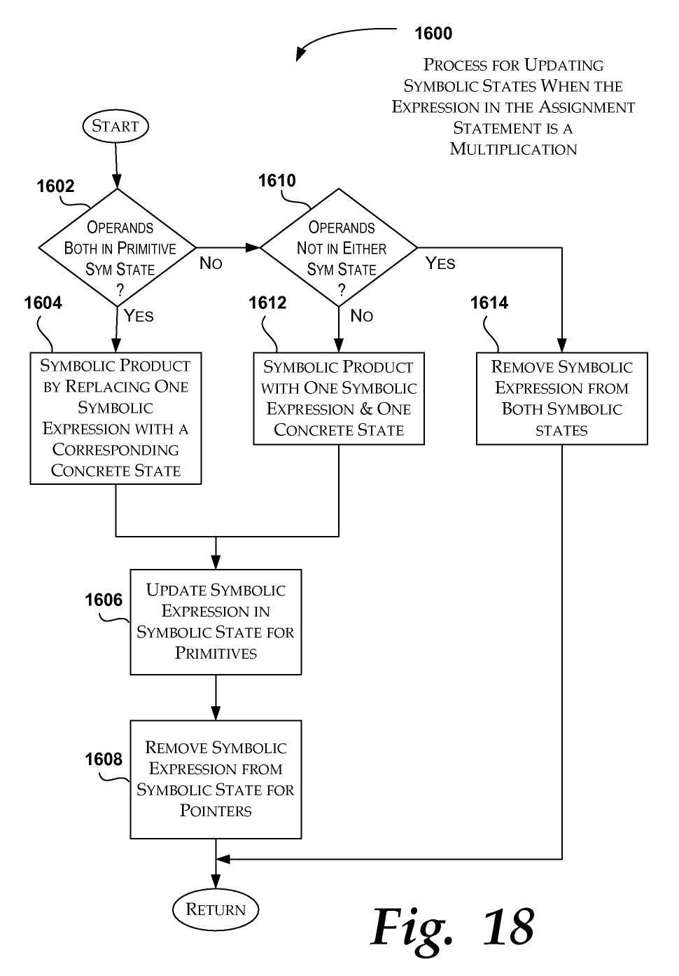

FIG. 18 is a flow diagram that illustrates one embodiment of a process for updating the symbolic states suitable for use within the process 900 of FIG. 11 when the expression in the assignment statement is a multiplication. At decision block 1702, a check is performed to determine whether the operands are both in the primitive symbolic state. If both operands are in the symbolic state for primitives, processing continues to block 1604, block 1606, and block 1608 before returning. At block 1604, a symbolic product is performed by replacing one symbolic expression with a corresponding concrete state. At block 1606, the symbolic state for primitives is updated. At block 1608, the symbolic expression is removed from the symbolic state for pointers.

If the operands are not in the primitive symbolic state, processing continues at decision block 1610. At decision block 1610, a determination is made whether at least one operand is the symbolic state for primitives. If this is true, a symbolic product is performed with one symbolic expression and one concrete state (block 1612) before proceeding to blocks 1606-1608. One will note that the symbolic state for pointers need not be evaluated if multiplication of pointers is not supported. If none of the operands are in the primitive symbolic state, both locations are removed from the symbolic state (block 1614). Processing is then complete.

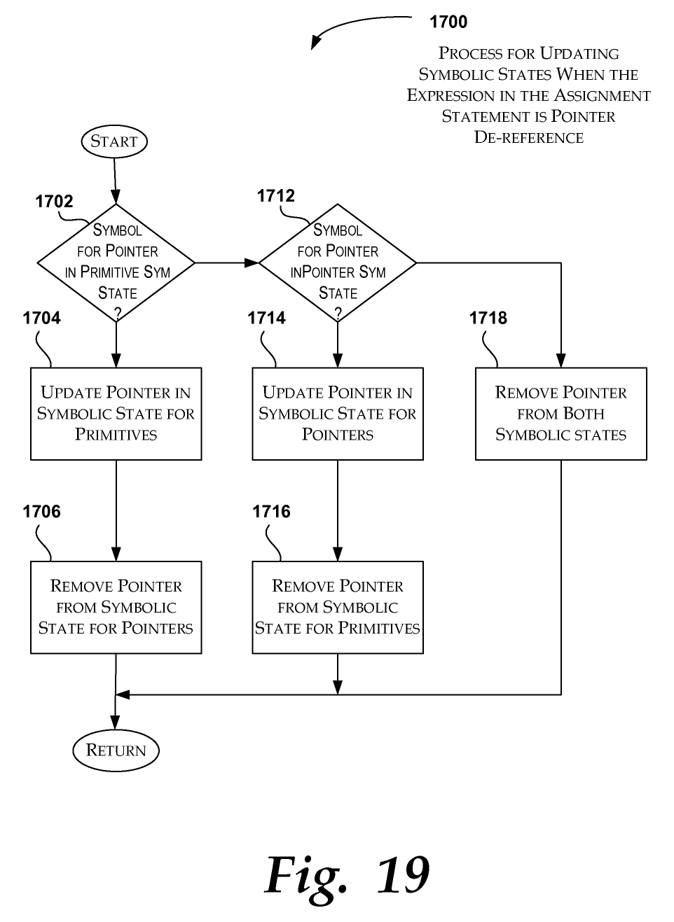

FIG. 19 is a flow diagram that illustrates one embodiment of a process for updating the symbolic states suitable for use within the process 900 of FIG. 11 when the expression in the assignment statement is a pointer de-reference. At decision block 1702, a check is performed to determine whether the symbol for the pointer is in the symbolic state for primitives. If so, processing continues to block 1704 and block 1706, before returning. At block 1704, the pointer symbol in the symbolic state for primitives is updated. At block 1806, the pointer is removed from the symbolic state for pointers.

If the symbol for the pointer was not in the symbolic state for primitives, processing continues at decision block 1712. At decision block 1712, a check is made to determine whether the symbol for the pointer is within the symbolic state for pointers. If the symbol for the pointer is in the symbolic state for pointers, processing continues to block 1714 and block 1716, before returning. At block 1714, the pointer symbol in the symbolic state for pointers is updated. At block 1806, the pointer is removed from the symbolic state for primitives. If the symbol for the pointer is not within either symbolic state, the pointer is removed from both symbolic states. Processing is then complete.

Table 3 illustrates exemplary code that symbolically executes an assignment statement.

```
TABLE 3
// inputs: m is a memory location
// e is an expression to evaluate
// modifies A and P by symbolically executing *m ← e
execute_symbolic(m, e)
    if (i ≦ depth)
    match e:
        case “v₁”:
            m₁ = &v₁;
            if (m₁ ε domain(P)) A = A − m; P = P [m [symbol]  P (m₁)]; //remove if A contains m
            else if (m₁ ε domain (A)) A = A [m [symbol]  A (m₁)]; P = P − m;
            else P = P − m; A = A − m;
        case “v₁ ± v₂”: // where ± ε {+, −}
            m₁ = &v₁; m₂ = &v₂;
            if (m₁ ε domain (A) and m₂ ε domain (A)) v = “A (m₁) ± A (m₂)”; //symbolic add or subtract
            else if (m₁ ε domain (A)) v = “A (m₁) ± v₂”; //symbolic add or subtract
            else if (m₂ ε domain (A)) v = “v₁ ± A (m₂)”; //symbolic add or subtract
            else A = A − m; P = P − m; return;
            A = A [m [symbol]  v]; P = P − m;
        case “v₁ * v₂”:
            m₁ = &v₁; m₂ = & v₂;
            if (m₁ ε domain (A) and m₂ ε domain (A)) v = “v₁ * A (m₂)”; //replace one with concrete val
            else if (m₁ ε domain (A)) v = “A (m₁) * v₂”; //symbolic multiply
            else if (m₂ ε domain (A)) v = “v₁ * A (m₂)”; //symbolic multiply
            else A = A − m; P = P − m; return;
            A = A [m [symbol]  v]; P = P − m;
        case “*v₁”:
            m₂ = v₁;
            if (m₂ ε domain (P)) A = A − m; P = P [m → P (m₂)];
            else if (m₂ ε domain (A)) A = A [m [symbol]  A (m₂)]; P = P − m;
            else A = A − m; P = P − m;
        default:
            A = A − m; P = P − m;
```

A represents the symbolic state for primitives, P represents the symbolic state for pointers, m is a memory location, and e is an expression to evaluate. Given any map M (e.g., A or P), M′=M[m [symbol] v] denotes the map that is the same as M except that M′(m)=v. Also, M′=M−m denotes the map that is the same as M except that M′(m) is undefined. The notation mεdomain(M) represents a check whether M (m) is defined.

FIG. 12 is a flow diagram that illustrates one embodiment of a process 1000 for symbolically evaluating a conditional statement which is suitable for use within the software testing process of FIG. 8. Process 1000 begins at optional decision block 1002. Optional decision block 1002 is implemented if a depth has been set for a bounded depth first search. At decision block 1002, a determination is made whether the set depth has been reached. If the depth has been reached, symbolic processing is not performed and processing proceeds to the return. Otherwise, processing continues at decision block 1004.

At decision block 1004, the predicate is checked to determine whether it is an inequality, such as <, >, or the like. If the predicate is not an inequality, processing continues at decision block 1010. Otherwise, processing continues at block 1006.

At block 1006, the primitive variables are checked to determine whether they are within the symbolic state for primitives. Because the present software testing technique uses pointer constraints that conform to x=y, x≠y, x=NULL, and x≠NULL, the symbolic state for pointers need not be checked at block 1006. After this determination, processing continues at block 1008 where a computed constraint is set. If both variables are in the symbolic state for primitives, both their symbolic expressions are used to set the computed constraint in block 1008. For example, if x₁ and x₂ are in the symbolic state, then the computed constraint may be x₁>x₂. However, if one of the variables does not have a corresponding symbolic expression, the variable itself may be used to set the computed constraint. For example, for x>1, the number one does not have a corresponding symbolic expression, therefore, the computed constraint is x>1. Processing continues at decision block 1018.

At decision block 1018, the concrete value of the predicate is evaluated. In essence, the concrete value represents the outcome (e.g., true/false may correspond to if/then outcome, respectively) of the branch that was traversed. If the concrete value is true, processing continues at block 1020 where the current path constraint is extended with the computed constraint. Otherwise, processing continues at block 1024, where the current path constraint is extended with the negated computed constraint. The current path constraint represents the execution path for the current iteration. Processing then returns to FIG. 8.

At decision block 1010, the predicate is evaluated to determine whether it is an equality or a disequality, such as = or ≠. If the predicate is an equality or a disequality, processing continues at block 1012. At block 1012, both of the symbolic states are checked for the variables. Processing then continues at block 1014 where the computed constraint is set. The computed constraint is computed as described above except that the constraint is an equality or a disequality. It is important to note that even though simple pointer constraints are used, a precise relationship between pointers is maintained in the logical input map. The logical input map (through types) maintains a relationship between pointers to structs and their fields and between pointers to arrays and their elements. Thus, the logical input map allows the use of simple scalar symbolic variables to represent the memory and still obtains fairly precise constraints. Processing continues to decision block 1018 and proceeds as described above.

If the predicate is not an inequality or equality/disequality, then processing continues at block 1016, where the computed constraint is set to the concrete value of the predicate. This represents a case in which the symbolic predicate expression is constant. Therefore, a constraint can not be changed to test the other path. Processing continues to decision block 1018 and proceeds as described above.

In one embodiment, the symbolic expressions from the branching points due to the conditional statements in the software program are collected in an array that represents the current path constraint. At the end of the execution, the current path constraint, path_c[0 . . . i−1], where i is the number of conditional statements in the instrumented code, contains the predicates whose conjunction holds for the current execution path. By saving the execution path for each execution iteration of the instrumented code, process 600 can determine when the feasible paths of the instrumented code have each been tested. Table 4 illustrates exemplary pseudo-code that symbolically evaluates a predicate.

TABLE 4

```
// inputs: p is a predicate to evaluate
// b is a memory location
// modifies path_c by symbolically evaluating p
evaluate_predicate(p, b)
if (i ≦ depth)
    match p:
        case “v₁ ∞ v₂”: // where ∞ ε {<,≦,≧,>}
            m₁ = & v₁; m₂ = & v₂;
            if (m₁ ε domain(A) and m₂ ε domain(A))
                c = “A(m₁) − A(m₂) ∞ 0”;
            else if (m₁ ε domain(A))
                c = “A(m₁) − v₂ ∞ 0”;
            else if (m₂ ε domain(A))
                c = “v₁ − A(m₂) ∞ 0”;
            else c = b;
        case “v₁ ≈ v2”: //where ≈ ε {=, ≠}
            m₁ = & v₁; m₂ = & v₂;
            if (m₁ ε domain(P) and m₂ ε domain(P))
                c = “P(m₁) ≈ P(m₂)”;
            else if (m₁ ε domain(P) and v₂ == NULL)
                c = “P(m₁) ≈ NULL”;
            else if (m₂ ε domain(P) and v₁ == NULL)
                c = “P(m₂) ≈ NULL”;
            else if (m₁ ε domain(A) and m₂ ε domain(A))
                c = “A(m₁) − A(m₂) ≈ 0”;
            else if (m₁ ε domain(A)) c = “A(m₁) − v₂ ≈ 0”;
            else if (m₂ ε domain(A)) c = “v₁ − A(m₁) ≈ 0”;
            else c = b;
    if (b) path_c[i] = c;
    else path_c[i] = neg(c);
    cmp_n_set_branch_hist(true);
    i = i + 1;
```

The symbol p is a predicate to evaluate, b is the concrete value of the predicate in S, A is the symbolic state for primitives and P is the symbolic state for pointers.

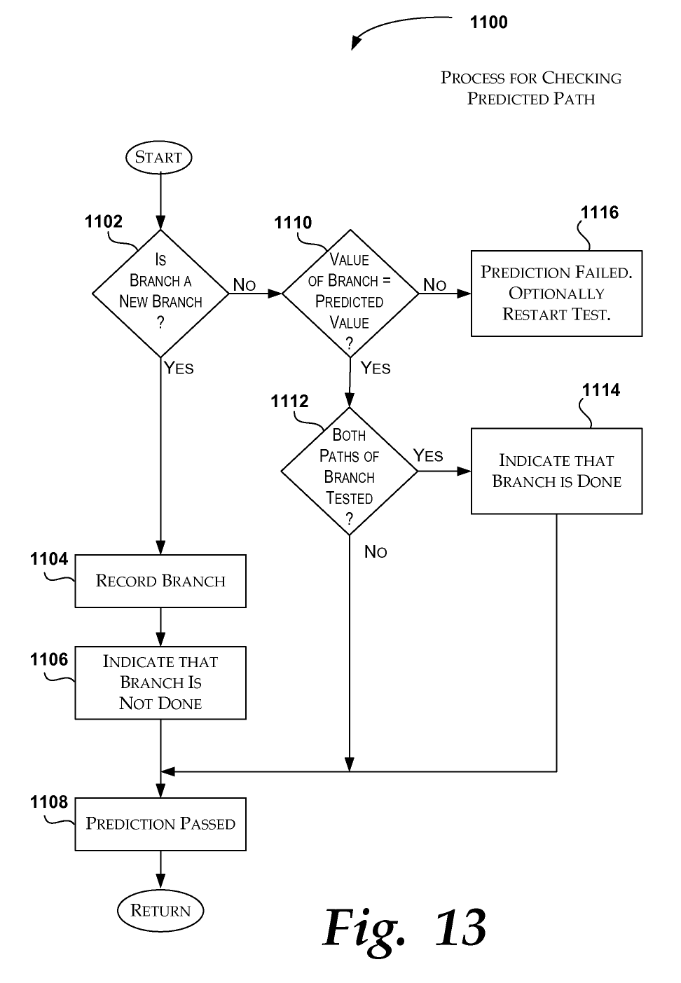

FIG. 13 is a flow diagram that illustrates one embodiment of a process for checking the predicted path which is suitable for use within the software testing process of FIG. 8. Process 1100 begins at decision block 1102 where a determination is made whether the current branch is a new branch that is being traversed. If the current branch is a new branch, processing continues at block 1104.

At block 1104, the new branch is recorded in the branch history. As mentioned above, the branch history may be maintained for each iteration so that the testing technique can determine when all the branches have been tested. Processing continues at block 1106.

At block 1106, the branch history for the branch may be set to indicate that this testing of this branch is done. This information will be used when that last constraint can not be negated. When that occurs, back tracking checks which branches are done in order to locate a constraint that should be negated. This will be explained later in conjunction with FIG. 14 on constraint solving. Processing continues at block 1108.

At block 1108, an indication that the prediction passed is relayed back to processing within FIG. 8. This will indicate to process 600 that the prediction was satisfied and that normal processing may continue.

If the current branch is not a new branch at decision block 1102, processing continues at decision block 1110 where the branch is compared with the predicted branch. In one embodiment, each branch may be represented with a true/false, and be indexed such that the first conditional corresponds to index 0, the second conditional corresponds to index 1, and so on. The comparison then compares the true/false value of the current branch with the true/false value in the predicted path. If the comparison passes, processing continues at decision block 1112.

At decision block 1112, a determination is made whether both paths of the branch have been tested. Once both paths of the branch have been tested, the software testing technique no longer needs to test this branch. This eliminates the redundant testing of branches. If both paths have not been tested, processing continues at block 1108. If both paths have been tested, processing continues at block 1114 where an indication that the branch is done is set. Processing continues at block 1108 which informs process 600 of a successful prediction.

In the event that the current branch does not match the predicted path, processing continues at block 1116. At block 1116, an indication that a prediction failed may be provided. In addition, process 600 may be restarted. This allows new test values to be input which will hopefully not results in the same failure.

FIG. 14 is a flow diagram that illustrates one embodiment of a process 1200 for solving constraints and determining a new logical input map which is suitable for use within the software testing process of FIG. 8. Process 1200 utilizes and builds upon a conventional constraint solver for linear arithmetic constraints, such as the well known constraint solver lp_solve. Process 1200 begins at decision block 1202, where a determination is made whether the last constraint should be syntactically negated. As long as both outcomes of the constraint have not been performed, the last constraint should be negated. If the last constraint can be syntactically negated, the solver does not need to invoke the expensive semantic check (block 1220). Experimental results show that this optimization reduces the number of semantic checks by 60-95%. However, if the last constraint can not be negated, processing proceeds to block 1220. Otherwise, processing continuing at block 1204.

At block 1204, the last constraint is negated. At block 1206, the set of predicates then includes the negated constraint. Processing continues at decision 1208 in order to compute a new input graph.

At block 1208, a determination is made whether the set of predicates are linear arithmetic predicates or pointers. If the set of predicates are pointers, processing continues at block 1214. If the set of predicates are linear arithmetic predicates, processing continues at block 1210.

At block 1210, a conventional linear technique may be performed to compute the new logical input map. Process 1200 is then complete.

At block 1214, a pointer technique is used to compute the new logical input map in accordance with one embodiment of the present software testing technique. The pointer technique is described below in conjunction with FIG. 15. After the new logical input map is computed, the constraint solving process is complete.

However, as mentioned above, if the last constraint should not be negated, then a semantic check must be performed to locate the last unnegated constraint. At block 1220, the last unnegated constraint is obtained. This is achieved by back tracking up the path constraint to determine a constraint which should be negated. In one embodiment, a backtrack indicator associated with each branch is modified to indicate that the entire branch has been tested. Once a constraint is identified, processing continues at block 1222.

At block 1222, common arithmetic sub-constraints are identified and removed. Thus, the solver identifies and eliminates common arithmetic sub-constraints before passing them to lp_solve. Processing continues at block 1224.

At block 1224, a set of predicates in the current path constraint are obtained that are dependent on the negated current path. By identifying these dependencies, the dependencies can be exploited in order to solve the constraints faster and keep the solutions similar. This optimization, along with block 1222, has shown a significant reduction in the number of sub-constraints, such as a 64% to 90% reduction. This allows the constraints to be solved faster and the solutions to be kept similar. The set is determined on the following observation. Given a predicate p in C, vars(p) may be defined to be the set of all symbolic variables that appear in p. Given two predicates p and p′ in C, p and p′ are dependent if one of the following conditions holds: 1) the intersection of the set of all symbolic variables in p with the set of all symbolic variables in p′ is not zero; or 2) there exists a predicate p″ in C such that p and p″ are dependent and p′ and p″ are dependent. Two predicates are independent if the predicates are not dependent.

The following observation allows the constraint solver in the present software testing technique the ability to solve constraints efficiently and in an incremental manner. It was observed that the path constraints C and C″ from two consecutive execution iterations differ in a small number of predicates. In particular, they differ in the last predicate when there is not backtracking up the tree. Thus, their respective solutions for the logical input map I and I″ agree on many of their mappings.

By obtaining the set of predicates in C (the current path constraint) that are dependent on the negated current path, it was found that either all the predicates in the set were linear arithmetic predicates or pointer predicates, because no predicate in C contains both arithmetic symbolic pointers and pointer symbolic variables. Based on experimental results, the size of this set of predicates may be almost one-eighth the size of C on average. For example, if D represents the subset of predicates that are dependent on the negated current path, let D′ represents the subset of D that does not contain the predicate [symbol] path_c[j]. The solver first checks if [symbol] path_c[j] is consistent with the predicates in D. For this, the solver constructs an undirected graph whose nodes are the equivalence classes (with respect to the relation =) of all symbolic variables that appear in D′. The symbol [x]_ denotes the equivalence class of the symbolic variable x. Given two nodes denoted by the equivalence classes [x]₌ and [y]₌, the solver adds an edge between [x] and [y] if and only if there exists symbolic variables u and v such that u≠v exists in D′ and uε[x]₌ and vε[y]₌. Given the graph, the solver finds that [symbol] path_c[j] is satisfiable if [symbol] path_c[j] is of the form x=y and there is no edge between [x]₌ and [y]₌ in the graph; otherwise, if [symbol] path_c[j] is of the form x≠y, then [symbol] path_c[j] is satisfiable if [x]₌ and [y]₌ are not the same equivalence class. If [symbol] path_c[j] is satisfiable, the solver computes the new logical input map according to block 1114. Processing then continues to decision block 1208 to determine how to find the new logical input map based on the set of dependent predicates as described above. However, this time each predicate in the set are evaluated.

FIG. 15 is a flow diagram that illustrates one embodiment of a “pointer” process 1300 for determining a new logical input map which is suitable for use within the process for solving constraints of FIG. 14. Process 1300 begins at decision block 1302 where a determination is made whether the constraint is in the form “x≠NULL”. If the constraint is in the form “x≠NULL”, processing continues at block 1304. Otherwise, processing continues at decision block 1306.

At block 1304, the “x” node is added to the current input graph. Adding a node may be implemented in several ways. In one embodiment, a node may be added by placing a pre-determined value, such as −1, in the corresponding address in the logical input map. Processing is then complete.

At decision block 1306, a determination is made whether the constraint is in the form of “x=NULL”. If the constraint is in the form “x=NULL”, processing continues at block 1308. Otherwise, processing continues at decision block 1310.

At block 1308, the “x” node is added to the current input graph. Processing is then complete.

At decision block 1310, a determination is made whether the constraint is in the form of “x=y”. If the constraint is in the form “x=y”, processing continues at block 1312. Otherwise, processing continues at decision block 1314.

At block 1312, the value stored for the aliased pointer is assigned the value of the aliased pointer in the current input graph. Processing is then complete.

At decision block 1314, a determination is made whether the constraint is in the form of “x≠y”. If the constraint is in the form “x≠y”, processing continues at block 1316. As mentioned above, the present software testing technique keeps the symbolic pointers simple. Therefore, the symbolic pointer will be one of the above four forms.

At block 1316, the aliased pointer is removed from the current input graph. Processing is then complete.

Pseudo-code for an example race-detection and flipping process for automatic testing of multi-threaded programs is illustrated in Table 5. For ease of description, this example pseudo-code assumes that the program being tested has no data input. Additional examples including programs with data input are included below.

In the example process illustrated by the pseudo-code of Table 5, Ex(P) refers to the set of all feasible execution paths that can be exhibited by the program P on all possible values of inputs and all possible schedules. REx(P) is a representative set of executions and refers to the set that contains one candidate from each equivalence class of feasible execution paths of P. Two execution paths are in the same equivalence class if they have the same events and the multiple threads, or processes or actors or agents or choice of messages to such processes or actors or agents, are executed in the same order, if such order can affect the outcome, for example by writing and reading from the same variable (memory location), even if data inputs are different. A similar analysis is also applied in case of distributed memory message passing concurrent programs, except that instead of memory locations, scheduling of processes or actors instead of threads, and messages to the same process or actor instead of access to shared variables, are considered.

In Table 5, test_program(P) repeatedly executes the program P with different schedules until all paths in a REx(P) have been explored. Given two sequences of events τ and τ′, ττ′ denotes the concatenation of the two sequences. Given a sequence of events τ and an event e, τe denotes the concatenation of the sequence and the event. Additionally, ε refers to the empty sequence. A sequence of events is called a prefix if it is the prefix of a feasible execution path.

The global variable τ keeps track of the execution path for each execution of P. At the end of each execution, τ is appropriately truncated so that a depth-first search of the computation tree takes place. execute_prefix(P, τ) executes the program from the beginning until the sequence of events generated by the execution is equal to the prefix τ. An event can be represented as a tuple (t,l,a), where l is the label of the statement executed by thread t and a is the type of shared memory access in the statement. So, (t,-,-) represents an event on the thread t. With every prefix τ an associated set is denoted as postponed(τ), and an associated Boolean flag is denoted as race(τ). enahled(τ) returns the set of threads that are enabled after executing the prefix τ. enabled(τ)\postponed(τ) represents the set of threads that are enabled but not postponed after executing τ.

In each execution of P during the testing process, P is first partly executed so that it follows the prefix τ computed in the previous execution. Then P is executed with the default schedule, where the lowest indexed enabled thread is chosen. If τ=τ′e before the start of execution, then the execution path and the previous execution path has the same prefix τ′. In an execution path τ, for any prefix τ′ of τ, race(τ′) is set to true if there exists e, τ₁,e′, and τ₂ such that τ=τ′eτ₁e′τ₂ and e<·e′. The symbol <· denotes a race condition exists, so e<·e′ indicates that a race condition exists between e and e′.

Setting race(τ′) to true flags that in a subsequent execution, execution of e is to be postponed after the prefix τ′ so that a possibly non-equivalent execution path can be explored. At the end of an execution, if τ₁ is the longest prefix of the execution path τ such that race (τ′) is set to true and |enabled(τ₁)\postponed(τ₁)|>1, a new schedule is generated by truncating τ to τ₁e, where e is an event of a thread t that has not been scheduled after τ₁ in any previous execution.

TABLE 5

```
global var τ= ε; //the empty sequence
//input: P is the program to test
test_program(P)
    while testing not complete
        execute_program(P)
execute_program(P)
    execute_prefix(P, τ);
    while there is an enabled thread
        execute the next statement
        of the lowest indexed enabled thread in P to
            generate the event e;
        race(τ)=false;
        postponed(τ)=Ø;
        append e to τ;
        if ∃ e' ε τ such that e' <e
            let τ= τ₁e'τ₂ in race(τ₁) = true;
    //end of the while loop
    if there is an active thread
        print “Error: found deadlock”;
//modifies τ
generate_next_schedule( )
    if ∃ e such that τ == τ₁eτ₂ and backtrackable(τ₁) and
        there is no e' such that τ == τ'₁e'τ'₂ and
        |τ₁| < | τ'₁ | and backtrackable( τ'₁ )
            race(τ₁) = false;
            let (t,-,-) = e in add t to postponed(τ₁);
            let t = smallest indexed thread in
            enabled(τ₁)\postponed(τ₁) in τ = τ₁(t,-,-);
    else
        testing completed;
backtrackable(τ₁) =
    race(τ₁) == true and |enabled(τ₁)\postponed(τ₁)|>1
```

The pseudo code of Table 5 illustrates an example of the race-detection and flipping process for automatic testing of multi-threaded programs where the program being tested has no data input. This process can also be extended to the automatic testing of multi-threaded programs that do have data input. This extension is discussed herein with reference to combining the concrete execution and symbolic execution testing of the program with the race-detection and flipping process.

The instrumentation of the code being tested adds code so that the interleaving of the various threads at runtime can be controlled. As discussed above, a call to the procedure access_event is added before any access to a potential shared memory location, a call to the procedure fork_event is added after forking a new thread, and a call to the procedure end_event is added after terminating a thread. After the START statement in a program, code is added to create a new thread and execute the procedure testing_scheduler in that newly created thread. The testing_scheduler controls the execution of the other threads at runtime, allowing the program to be executed according to a particular schedule. The testing_scheduler also permits only one thread to be executing at a time. This serialization of the execution of various threads allows the testing_scheduler to ensure that there is no uncontrolled concurrency in the system.

Assume that the thread running the testing_scheduler procedure is denoted as schedulerThread. A variable thisThread is used to denote the current thread (i.e., the thread accessing the variable thisThread). The execution of various threads is controlled using binary semaphores. Table 6 illustrates an example of pseudo-code for an implementation of a binary semaphore. A call to the procedure wait on a semaphore s makes the calling thread wait until the value of s is 1. Once the value is 1, it sets the value of s to 0 atomically. A call to the procedure signal on a semaphore s sets the value of s to 1 atomically; this signals any thread waiting on s. A binary semaphore is associated with each thread at the time of its creation, and the binary semaphore is initialized to 0. The semaphore associated with the thread t is denoted as t.semaphore.

TABLE 6

```
//Semaphore s is passed by reference in the following procedures
init(Semaphore s){
    s=0;
}
wait(Semaphore s){
    await s==1, then s=0; //must be atomic once s==1 is detected
}
signal(Semaphore s){
    s=1; //must be atomic
}
```

An example of the various thread controlling procedures that are added by instrumentation are described in Table 7. In an execution, before any access to a shared memory location, a thread t calls the procedure access_event. The access_event procedure first executes signal(schedulerThreadsemaphore) to signal the schedulerThread thread to continue its execution. Then the access_event procedure executes wait(thisThreadsemaphore) to make t wait for a signal from the schedulerThread thread. This way t releases the control to the schedulerThread thread and allows schedulerThread to schedule an appropriate thread from the set of enabled threads. Note that, although the thread trying to access the shared memory is waiting on its semaphore, it is still enabled.

A thread also starts waiting on its semaphore when it forks another thread. However, in this case the thread calling fork does not signal the schedulerThread thread because after the execution of fork the child thread starts its execution and typically there is only one thread executing at any time during an execution.

The schedulerThread, after receiving a signal from an executing thread, starts its job of picking the next thread to be scheduled for execution. Whenever schedulerThread receives a signal from a thread, it knows that all the active threads in the execution are waiting to access a shared memory location. Then it determines if there is at least one thread that is enabled among the waiting threads (in other words, is there a thread that is not waiting to acquire a lock that is already acquired by some other thread). If there is at least one enabled thread, then schedulerThread picks the same thread as the previous execution while i is less than the number of elements of event. This causes the current execution to follow the schedule computed in the previous execution while i is less than or equal to the length of event. At the end of the previous execution, the sequence event is truncated appropriately and concatenated with an event to perform a depth-first search of the feasible execution paths of P. Otherwise, if i is greater than the number of elements in event, schedulerThread selects the smallest indexed thread that is enabled.

After selecting a thread, schedulerThread signals the selected thread and starts waiting again for a signal. If after getting a signal schedulerThread determines that none of the threads are enabled and there is at least one active thread in the execution, then schedulerThread flags that there is a deadlock situation. Otherwise, if there is no enabled or active thread in the execution, then the program execution terminates and schedulerThread computes a schedule or an input for the next execution using the procedure compute_next input_and_schedule.

Pseudo-code for an example of the compute_next_input_and_schedule procedure is described in Table 8. The compute_next_input_and_schedule procedure computes the schedule and the input that will direct the next program execution along an alternative execution path. The compute_next_input_and_schedule procedure loops over the choice points in the current execution from the end. The choice points refer to events in the execution path where a constraint or race condition is found. If the selected choice point j inside the loop contains a scheduler choice and if not all scheduler choices at the choice point have been exercised, then a new schedule is generated.

Specifically, if the thread t executed at the execution point denoted by the element event[j] and if t can be added to postponed[j] without making postponed[j] equal to the set of enabled threads at the choice point, then t is added to the set postponed[j]. Additionally, the smallest indexed thread, which is in the set of enabled threads at the choice point and which is not in the set postponed[j], is chosen and assigned to event[j]. This causes, in the next execution at the same choice point, schedulerThread thread to pick a thread that is enabled and that is not in postponed[j]. Thus, in subsequent executions, all the threads that are enabled at the choice point will get scheduled one by one. Otherwise, if at the selected choice point path_c[j] is defined and if the constraint path_c[j] has not been negated previously, then constraint solving is invoked to generate a new input.

TABLE 7

```
testing_scheduler( )
    wait(schedulerThread.semaphore);
    while there is an enabled thread
        if i ≦ |events|
            (t_{current},-,-) = event[i];
        else
            t_{current}=lowest indexed thread in the set of enabled threads
        signal(t_{current}.semaphore); //release control to the thread t_{current}
        wait(schedulerThread.semaphore); //wait for the thread t_{current} to give back control
    //end of the while loop
    if there is an active thread
        print “Error: found deadlock”;
    compute_next_input_and_schedule( ) ;
access_event(m, label, access_type) // access_type can be r (read), w (write), l (lock), u (unlock)
    signal(schedulerThread.semaphore); // release control to the testing scheduler
    wait(thisThread.semaphore); //wait for the testing scheduler to give back control
    event[i] = (thisThread, label, access_type);
    enabled[i] = set of enabled threads;
    i = i + 1;
fork_event( )
    wait(thisThread.semaphore); //wait for the testing scheduler to give back control
end_event( )
    signal(schedulerThread.semaphore); //release control to the testing scheduler
```

TABLE 8

```
compute_next_input_and_schedule( )
  for (j = i − 1; j ≧ 0; j = j −1)
    if event[j] is defined
      //compute a new schedule
      if |enabled[j]| > |postponed[j]| + 1
        (t,-,-) = event[j];
        postponed[j] = postponed[j] ∪ {t};
        t = smallest indexed thread in enabled[j]\postponed[j];
        event[j] = (t,-,-);
        branch_hist = branch_hist[0...j];
        event = event[0...j];
        postponed = postponed[0...j];
        return;
      else
        //compute a new input
        if (branch_hist[j].done == false)
          branch_hist[j].branch = [symbol]  branch_hist[j].branch;
          if ( ∃ I' that satisfies neg_last(path_c[0...j]))
            branch_hist = branch_hist[0...j];
            event = event[0...j];
            postponed = postponed[0...j];
            return;
  //end of the for loop
  if (j < 0) completed = true;
```

The examples in Tables 7 and 8 above do not leverage all the benefits of the concrete execution and symbolic execution testing of the program. However, these examples can be extended to better leverage the concrete execution and symbolic execution testing of the program discussed above. An example of the various thread controlling procedures that are added by instrumentation and that are combined with the concrete execution and symbolic execution are described in Table 9. Pseudo-code for an example of the compute_next_input_and_schedule procedure that is combined with the concrete execution and symbolic execution is described in Table 10.

Combining the race-detection and flipping with the concrete execution and symbolic execution explores a smaller superset of the execution paths in REx(P). The process accomplishes this by computing race conditions between different events in an execution. Based on these race conditions, the process generates other schedules that flip the race conditions to provide a depth-first search of all permutations of the race conditions in the execution path.

More specifically, assume that e₀e₁e₂ . . . eₙ is an execution path of a program and that eᵢ and eⱼ (where i<j) are related by a race relation (eᵢ<·eⱼ). The event eᵢ is marked by setting race[i] to true to indicate that it has a race with some future event and that the tread of eᵢ is to be postponed at that execution point in some future execution so that the race relation between eᵢ and eⱼ gets flipped. While computing the next input and schedule at the end of the execution, if a choice is made to backtrack at the event eᵢ, then a schedule is generated for the next execution that continues the execution up to the prefix e₀ . . . eᵢ₋₁; however, after that the execution of the thread of eᵢ is postponed as much as possible. This causes the race between eᵢ and eⱼ to be flipped or permuted (i.e. eⱼ<·eᵢ) in the next execution, and an execution path of the form e₀ . . . eᵢ₋₁eᵢ₊₁ . . . eⱼe′ⱼ₊₁ . . . eᵢ . . . e′_{n′}. For example, if t₁:x=1, t₂:x=2 is an execution path, then there is a race condition in the accesses of the shared variable x. A schedule is generated such that the next execution is t₂:x=2, t₁:x=1 (in other words, the accesses to x are permuted or flipped).

In the example described in Table 9, it is assumed that the scheduler maintains a dynamic vector clock and a sequential vector clock with each thread and two dynamic vector clocks with each shared memory location. A dynamic vector clock V:T→N, where T is the set of threads that are present in the execution, reflects the intuition that threads are dynamically created and destroyed. Each dynamic vector clock (DVC) V is represented as a map, where V(t)=0 whenever V is not defined on thread t (e.g., if t has not been created).

A DVC is associated with every thread t and is denoted by Vₜ. Two DVCs Vₘ^{a} (access DVC) and Vₘ^{b} (updated DVC) are also associated with every shared memory location m. By definition, for any two maps V and V′, V≦V′ if and only if V(t)≦V′(t) for all tεT; V≠V′ if and only if V is not ≦V′ and V′ is not ≦V. Additionally, max {V, V′} is the DVC with the max {V, V′}(t)=max {V(t), V′(t)} for each tεT .

At the beginning of an execution, all vector clocks associated with threads and memory locations are empty. Whenever a thread t with current DVC Vₜ generates an event, a DVC process is executed as follows:
1. If e is not a fork event or a new thread event, then Vₜ(t)←Vₜ(t)+1.
2. If e is a read of a shared memory location m, then:

Vₜ←max{Vₜ,Vₘ^{w}}

Vₘ^{a}←max{Vₘ^{a},Vₜ}.
3. If e is a write, lock, or unlock of a shared memory location m, then:

Vₘ^{w}←Vₘ^{a}←Vₜ←max{Vₘ^{a},Vₜ}.
4. If e is a fork event and if t′ is the newly created thread, then:

V_{t′}←Vₜ

Vₜ(t)←Vₜ(t)+1

V_{t′}(t′)←V_{t′}(t′)+1.

If e is an event of thread t, then V{e} denotes the DVC of t after the event e, V{e}ₘ^{w} denotes the DVC Vₘ^{w} after the event e, and V{e}ₘ^{a} denotes the DVC Vₘ^{a} after the event e. If e is an event of thread t, then the event in thread (that happened immediately before e is denoted by prev(e), and the event in thread (that happened immediately after e is denoted by next(e).

The sequential relation between the events in an execution are tracked at sing sequential vector clocks (SVCs). A sequential vector clock is VS:T→N, where T is the set of threads that are present in the execution. Each SVC VS is a map, where VS(t)=0 whenever VS is not defined on thread t.

An SVC is associated with every thread and is denoted by VSₜ. At the beginning of an execution, all sequential vector clocks associated with threads are empty. Whenever a thread t with current SVC VSₜ generates an event, an SVC process is executed as follows:
1. If e is not a fork event or a new thread event, then VSₜ(t)←VSₜ(t)+1.
2. If e is a fork event and if t′ is the newly created thread, then:

VS_{t′}←VSₜ

VSₜ(t)←VSₜ(t)+1

VS_{t′}(t′)←VS_{t′}(t′)+1.

An SVC is associated with every event e, denoted by VSₑ as follows. If e is executed by t and if VSₜ is the vector clock of t just after the event e, then VSₑ=VSₜ.

The dynamic and sequential vector clocks are used to compute the race relation ( [symbol] ) in the procedure check_and_set_race. Although not illustrated in the example pseudo-code of Table 9 and 10, the vector clocks are updated according to the vector clock update processes discussed above.

The access_event procedure calls the procedure check_and_set_race. The procedure check_and_set_race determines if the current event has a race with any past event, event[j]. If such a race exists, then the race[j] is set to true. The process for selecting the next thread by the procedure testing_scheduler is modified so that a postponed thread's execution gets delayed as much as possible. The computation of the next input and the schedule is done using the procedure compute_next_input_and_schedule of Table 10. In the compute_next_input_and_schedule procedure, a new schedule which postpones the thread associated with an event is generated if the event has a race with a future event. In contrast, in the examples discussed above in Tables 7 and 8, a thread is postponed at an execution point even if the corresponding event has no race with any future event.

```
TABLE 9
testing_scheduler( )
    wait(schedulerThread.semaphore);
    t_{current} = NULL;
    while there is an enabled thread
        if i ≦ |event|
            (t_{current},-,-) = event[i];
        else
            if t_{current} is not enabled
                t_{current}=lowest indexed thread in the set of enabled threads
        //otherwise schedule the thread that was schedule in the last iteration
        signal(t_{current}.semaphore); //release control to the thread t_{current}
        wait(schedulerThread.semaphore); //wait for the thread t_{current} to give back control
    //end of the while loop
    if there is an active thread
        print “Error: found deadlock”;
    compute_next_input_and_schedule( ) ;
access_event(m, label, access_type) // access_type can be r (read), w (write), l (lock), u (unlock)
    signal(schedulerThread.semaphore); //release control to the testing scheduler
    wait(thisThread.semaphore); //wait for the testing scheduler to give back control
    event[i] = (thisThread, label, access_type);
    enabled[i] = set of enabled threads;
    check_and_set_race(m);
    i = i + 1;
fork_event( )
    wait(thisThread.semaphore); //wait for the testing scheduler to give back control
end_event( )
    signal(schedulerThread.semaphore); //release control to the testing scheduler
check_and_set_race(m)
    ∀ j ε [0, i ) such that event [j] < event[i]
        if e is a read or write event
            print “Warning: data race found”;
        race [j] = true;
```

TABLE 10

```
compute_next_input_and_schedule( )
  for (j = i − 1; j ≧ 0; j = j −1 )
    if event[j] is defined
      //compute a new schedule
      if |enabled[j]| > |postponed[j]| + 1
        if race [j]== true
          race [j]=false;
          (t,-,-) = event[j];
        postponed[j] = postponed[j] ∪ {t};
        t = smallest indexed thread in enabled[j]\postponed[j];
        event[j] = (t,-,-);
        branch_hist = branch_hist[0...j];
        event = event[0...j];
        postponed = postponed[0...j];
        return;
      else
        //compute a new input
        if (branch_hist[j].done == false)
          branch_hist[j].branch = [symbol]  branch_hist[j].branch;
          if( ∃ I' that satisfies neg_last(path_c[0...j]))
            branch_hist = branch_hist[0...j];
            event = event[0...j];
            postponed = postponed[0...j];
            return;
  //end of the for loop
  if (j < 0) completed = true;
```

It should be noted that, following the example of Tables 9 and 10, situations can arise that result in the repeated flipping of race relations between the same pair of events if the pair of events are not next to each other. For example, following the example execution path given above, if the next execution path is e₀ . . . eᵢ₋₁eᵢ₊₁ . . . eⱼe′ⱼ₊₁ . . . eᵢ . . . e′_{n′}, then the process may detect that there is a race between eⱼ and eᵢ. As a result, the process may attempt to flip this race once again. In order to avoid this, a sleep process is employed to delay the setting of the race condition being detected.

In one or more embodiments, this sleep process is carried out follows. In the execution path e₀ . . . eᵢ₋₁eᵢ₊₁ . . . eⱼe′ⱼ₊₁ . . . e′_{n′}, the thread t is added, where t is the thread of the event eᵢ, to the set delayed of every event eᵢ₊₁, . . . , eⱼ. As a result, even if a race between eⱼ and eᵢ is detected, the element of race corresponding to the event eⱼ is not immediately set to true. This prevents repeatedly flipping a race relation between the same pair of events. Table 11 illustrates example pseudo-code for testing_scheduler that incorporates this sleep process.

TABLE 11

```
testing_scheduler( )
    wait(schedulerThread.semaphore);
    while there is an enabled thread
        if postponed[i] is defined
            delayed = delayed ∪ postponed[i];
        sleep = {nextEvent(t) | t ε delayed};
        t_{current} = smallest indexed thread from set
        of enabled threads \ delayed;
        signal(t_{current}.semaphore); //release control
        to the thread t_{current}
        wait(schedulerThread.semaphore); //wait for
        the thread t_{current} to give back control
        ∀e ε sleep if e < event[i−1];
            let (t,-,-) = e in delayed = delayed \ t;
    //end of the while loop
    if there is an active thread
        print “Error: found deadlock”;
    compute_next_input_and_schedule( ) ;
```

Although the description above uses language that is specific to structural features and/or methodological acts in processes, it is to be understood that the subject matter defined in the appended claims is not limited to the specific features or processes described. Rather, the specific features and processes are disclosed as example forms of implementing the claims. Various modifications, changes, and variations apparent to those skilled in the art may be made in the arrangement, operation, and details of the disclosed embodiments herein.

What is claimed is:

1. One or more computer readable media having stored thereon multiple instructions that, when executed by one or more processors, cause the one or more processors to:
execute multiple actors of one or more programs following a first execution path;
identify a race condition among different ones of the multiple actors in the first execution path;
flip an order in which two events involved in the race condition are executed so as to create a second execution path;
execute the multiple actors following the second execution path; and
report any errors identified in the first execution path or the second execution path.

2. One or more computer readable media as recited in claim 1, the multiple actors comprising multiple threads of one of the one or more programs.

3. One or more computer readable media as recited in claim 1, the multiple instructions further causing the one or more processors to:
identify multiple additional race conditions among different ones of the multiple actors;
for each additional race condition, flip the order in which two events involved in the race condition are executed so as to create an additional execution path; and
execute each additional execution path.

4. One or more computer readable media as recited in claim 1, wherein a first event of the two events occurs before a second event of the two events in the first execution path, and wherein to flip the order in which the two events are executed is further to delay execution of the first event in the second execution path as long as possible.

5. One or more computer readable media as recited in claim 1, the multiple instructions further causing the one or more processors to execute the multiple actors following the first execution path and the second execution path using both concrete execution and symbolic execution.

6. One or more computer readable media as recited in claim 1, the multiple instructions further causing the one or more processors to:
identify a constraint encountered during execution following the first execution path;
negate the constraint;
identify an input value that satisfies the negated constraint; and
execute the one or more programs using the identified input value so as to create a third execution path.

7. One or more computer readable media as recited in claim 1, wherein to identify a race condition is to identify two statements in the multiple actors that are executed and that:
are included in two different actors of the multiple actors;
access a same memory location or send a message to a same actor of the multiple actors without holding a common lock; and
can have an the order in which the two statements are executed permuted by changing a schedule of the two different actors.

8. One or more computer readable media as recited in claim 1, the multiple instructions further causing the one or more processors to:
add one or more instructions to a program that, when executed by the one or more processors, cause the program to create a new thread and begin execution of a testing scheduler in the new thread, the testing scheduler controlling execution of the multiple actors.

9. A method for automatically testing one or more programs having multiple actors, the method comprising:
executing one or more events of the multiple actors following a first order;
reporting any errors identified during execution of the multiple actors following the first order; and
re-executing at least some of the one or more events following multiple different orders, the multiple different orders being determined based at least in part on different schedules for the multiple actors.

10. A method as recited in claim 9, the multiple actors comprising multiple threads of one of the one or more programs, and the different schedules comprising different thread schedules.

11. A method as recited in claim 9, the multiple different orders further being based at least in part on different test data inputs for the one or more programs.

12. A method as recited in claim 9, the different schedules being selected so that an order in which two different events that are part of a race condition are executed relative to one another is different.

13. A method as recited in claim 12, wherein a first event of the two different events occurs before a second event of the two different events in a first of the multiple different orders, and wherein execution of the first event is delayed in a second of the multiple different orders as long as possible.

14. A method as recited in claim 9, further comprising executing the one or more events using both concrete execution and symbolic execution.

15. A method as recited in claim 9, further comprising:
identifying a constraint encountered during execution of the one or more programs following the first order;
negating the constraint;
identifying an input value that satisfies the negated constraint; and
re-executing the one or more programs using the identified input value so as to create a different order.

16. A method as recited in claim 9, wherein the multiple different orders are selected at least in part in response to detected race conditions, and wherein a race condition is identified by identifying two statements in the one or more programs that:
are included in two different actors of the multiple actors;
access a same memory location or send a message to a same actor of the multiple actors without holding a common lock; and
can have an the order in which the two statements are executed permuted by changing a schedule of the two different actors.

17. A method as recited in claim 9, further comprising:
adding one or more instructions to one of the one or more programs that cause the one program to create a new thread and begin execution of a testing scheduler in the new thread, the testing scheduler controlling execution of the multiple actors.

18. A computing device comprising:
a processor; and
a computer readable media, coupled to the processor, to store multiple instructions that cause the processor to:
add instructions to a multi-threaded program to be automatically tested, the instructions causing the multi-threaded program to be executed multiple times with multiple different orders that are determined based at least in part on different thread schedules for the program.

19. A computing device as recited in claim 18, the multiple different orders also being based at least in part on different test data inputs for the program.

20. A computing device as recited in claim 18, the different thread schedules being selected so that an order in which two different events that are part of a race condition are executed relative to one another is different.

21. A computing device as recited in claim 20, wherein a first event of the two different events occurs before a second event of the two different events in a first of the multiple different orders, and wherein execution of the first event is delayed in a second of the multiple different orders as long as possible.

22. A computing device as recited in claim 18, wherein the multiple instructions further cause the processor to execute the multi-threaded program using both concrete execution and symbolic execution.

23. A computing device as recited in claim 18, wherein the instructions added to the multi-threaded program include instructions causing the processor to:
identify a constraint encountered during execution of the program following a first order;
negate the constraint;
identify an input value that satisfies the negated constraint; and
execute the program again using the identified input value so as to create a different order.

24. A computing device as recited in claim 18, wherein the multiple different orders are selected at least in part in response to detected race conditions, and wherein a race condition is identified by identifying two statements in the multi-threaded program that:
are included in two different threads;
access a same memory location without holding a common lock; and
can have an the order in which the two statements are executed flipped by changing a schedule of the two different threads.

25. A computing device as recited in claim 18, wherein the instructions added to the multi-threaded program include instructions causing the processor to:
create a new thread and begin execution of a testing scheduler in the new thread, the testing scheduler controlling execution of all other threads of the multi-threaded program.
